(19) United States
(12) Patent Application Publication
(10) Pub. No.: US 2004/0219297 A1
(43) Pub. Date: Nov. 4, 2004

(54) Washing, rinsing or cleaning products in portions in flexible water-soluble containers

(76) Inventors: Wilfried Raehse, Duesseldorf (DE); Sandra Hoffmann, Muenchen (DE)

Correspondence Address: HENKEL CORPORATION, THE TRIAD, SUITE 200, 2200 RENAISSANCE BLVD., GULPH MILLS, PA, 19406, US

(21) Appl. No.: 10/821,165

(22) Filed: Apr. 8, 2004

Related U.S. Application Data
(63) Continuation of application No. PCT/EP02/09970, filed on Sep. 6, 2002.

(30) Foreign Application Priority Data
Oct. 9, 2001 (DE) 101 49 718 0

(51) Int. Cl. C11D 17/00; B05D 3/12

(52) U.S. Cl. 427/292; 510/293

(57) ABSTRACT

A portioned washing, rinsing, or cleaning product, wherein a preparation is surrounded by an enclosure. The unfilled enclosure is deformable by a force F₁>0 N and ≦500 N along a path s₁ and, after the force has ceased, returns in the direction of its original shape with a recovery rate v>0 mm/min and ≦1000 mm/min. Also, a process for preparing the portioned product by injection molding, extrusion blowing, or thermoforming.

### CROSS REFERENCE TO RELATED APPLICATIONS

This application is a continuation under 35 U.S.C. § 365(c) and 35 U.S.C. § 120 of international application PCT/EP02/09970, filed Sep. 6, 2002. This application also claims priority under 35 U.S.C. § 119 of DE 101 49 718.0, filed Oct. 9, 2001, which is incorporated herein by reference in its entirety.

### BACKGROUND OF THE INVENTION

The present invention relates to products in portions, in particular to a washing, rinsing or cleaning product in portions in an enclosure made of water-soluble materials.

In virtually all areas of application of industrial products for domestic use, these products have to be packaged in order to protect them against environmental influences and/or to simplify their handling. Particularly in the case of products which are introduced into water in order to produce aqueous application liquors (washing or cleaning compositions, fertilizers, medicaments, animal feeds, vitamin preparations, colorants, disinfectants, etc.), packagings made of water-soluble materials have proven to be a consumer-friendly alternative since the consumer can insert the packaged product directly into the systems used for liquor preparation (washing machine, measuring beaker, bucket, spray device etc.), without having to take them out of the packaging. In addition, an exact dosage can be achieved in this way since the consumer no longer has to measure out quantities of powder or liquid, but merely uses one or more packaged units.

Such water-soluble packagings include, for example, film bags made of water-soluble polymers (so-called pouches) or—particularly in the pharmaceutical sector—gelatin capsules.

The pouches have the disadvantage that the film bags are very sensitive to mechanical influences. As a result, transportation or handling can lead to undesired product escape if the film is damaged as a result of carelessness. Mere handling with pointed or rough finger nails may lead to damage and thus to undesired consumer frustration particularly in the household product sector.

More stable containers have the disadvantage that they are brittle, get stress cracks or fractures upon shock-like stress (impact or fall) or are irreversibly deformed under the influence of force.

Relatively recent prior art publications disclose thermoformed water-soluble containers for agrochemicals such as crop protection agents: in WO 92/17382, a non-planar arc made of water-dispersible material is filled and closed with a “cover” made of water-dispersible material by means of an orbiting seam made of water-soluble or water-dispersible material.

WO 01/36290 discloses injection-molded hollow bodies made of water-soluble polymers for washing or cleaning products, medicaments or fertilizers and washing, rinsing or cleaning products which are present in such hollow bodies. However, the “containers” disclosed here are not flexible, but rigid and burdened with the disadvantages described above.

The object of the present invention was to provide a supply form for preparations of all kinds, in particular for washing, rinsing or cleaning products, which saves the consumer the burdensome dosing operation, but is free from the abovementioned disadvantages.

It has now been found that advantageous preparations can be formulated when the enclosure has certain mechanical properties which differ significantly from those of films or rigid containers.

### DESCRIPTION OF THE INVENTION

The present invention therefore provides a product in portions, comprising a preparation which is surrounded by an enclosure; where the unfilled enclosure is deformable by a force F₁ of >0 N and <500 N along a path S₁ and, after the influence of force has ceased, returns in the direction of its original shape and/or, after the influence of the deformation force has ceased, has a recovery rate v of >0 mm/min and ≦1000 mm/min.

As already mentioned above, the portions according to the invention are particularly suitable as washing, rinsing or cleaning products meaning that preferred preparations present in the enclosures are washing-active, rinsing-active or cleaning-active preparations.

The unfilled enclosure of the portioned products according to the invention can be at least partially reversibly deformed by the influence of force and, after the influence of force has ceased, has a certain recovery rate. High recovery rates (for example >2000 mm/min) are achieved here by rigid bodies, which “spring back” to the starting shape, if they do not remain in the indented state. This “springing back” behavior is undesired since, in this way, stress cracks may arise in the enclosure which permit product escape. It is thus required on the one hand to ensure a low recovery rate of the enclosure, and on the other hand the enclosure should be able to be deformed without breaking or cracking.

The force F₁ is dependent on the depth of indentation since the enclosure offers increasing resistance to the penetrating body. Firstly, it is the case for the present invention that the enclosure can be deformed at all at a force of 500 N or less. In preferred embodiments of the present invention, the data relating to forces refer to penetration depths of a round rod with 8 mm diameter of 10, preferably 15, particularly preferably 20 and in particular 22 mm.

If the distance s₁ is defined, it is possible to determine exactly not only the force, but also the deformation work. For the influence of force by a round rod with a diameter of 8 mm and a penetration depth of S₁=22 mm, the deformation work for the flexible, unfilled hollow bodies according to the invention is significantly below the values of comparable rigid unfilled bodies for which a deformation work of at least 5 Nm has to be exerted.

As mentioned above, the enclosures according to the invention should be able to be at least partially reversibly deformed (in the case or irreversible deformation, no recovery rate would be measurable). In preferred embodiments of the present invention, the deformation is completely reversible, i.e. there are products in portions according to the invention in which the unfilled enclosure returns to its original shape after the influence of force has ceased.

Preferably, the unfilled enclosure can be reversibly deformed even by relatively low forces. Preference is given here to products in portions according to the invention in which the unfilled enclosure is deformable by a force F₂ of ≦100 N, preferably by a force F₃ of ≦60 N, particularly preferably by a force F₄ of ≦40 N and in particular by a force F₅ of ≦20 N.

The recovery rate with which the unfilled enclosure approaches it original shape again after the influence of force has ceased is preferably likewise lower. Particularly preferred products in portions are characterized in that the unfilled enclosure, after the influence of force has ceased, has a recovery rate v of ≦500 mm/min, preferably v≦100 mm/min, particularly preferably v≦50 mm/min, further preferably v≦10 mm/min and in particular v≦1 mm/min.

If the distance s₁ is defined, then it is possible to determine exactly not only the force, but also the deformation work. For an influence of force by a round rod with a diameter of 8 mm and a penetration depth of 22 mm, the deformation work for unfilled enclosures of products in portions according to the invention is below certain values. Whereas rigid bodies require deformation works of at least 5 to 6 Nm, washing, rinsing or cleaning products in portions according to the invention are preferred in which a deformation work w≦5 Nm, preferably w≦1 Nm, particularly preferably w≦0.5 Nm, further preferably w≦0.3 Nm and in particular w≦0.25 Nm is required for the deformation of the unfilled enclosure.

The unfilled enclosure can preferably be “turned inside out”, i.e. it can be turned inside out such that the original inside becomes the outside and vice versa. This flexibility leads to the resistance, particularly increased compared to rigid moldings, against leakages under compressive stress (avoidance of stress cracks or fracture).

It is possible to make statements with regard to the filled enclosures (=the product comprising the filling and the enclosure) in an entirely analogous manner. The present invention therefore further provides a portioned washing, rinsing or cleaning product comprising a preparation which is surrounded by an enclosure, where the product (=the filled enclosure)

is deformable by a force F₁>0 N and ≦500 N, preferably by a force F₂≦100 N, particularly preferably by a force F₃≦60 N and in particular by a force F₄≦20 N and, after the influence of force has ceased, returns in the direction of its original shape and/or

has a recovery rate v of >0 mm/min and ≦1000 mm/min after the influence of deformation force has ceased.

It is also possible to make analogous statements with regard to the recovery rate for the filled enclosures. Products in portions according to the invention in which the product (=the filled enclosure), after the influence of force has ceased, has a recovery rate v of ≦500 mm/min, preferably v≦100 mm/min, particularly preferably v≦50 mm/min, further preferably v≦10 mm/min and in particular v≦1 mm/min, are preferred.

In accordance with the measurement conditions given above (round rod with a diameter of 8 mm, penetration depth 22 mm), preference is given to products in portions according to the invention in which a deformation work w of ≦5.0 Nm, preferably w≦2.5 Nm, particularly preferably w≦1.0 Nm, further preferably w≦0.75 Nm and in particular w≦0.5 Nm is required for the deformation of the product (=the filled enclosure).

A further parameter for characterizing particularly preferred products in portions according to the invention is the crushing resistance. This can be determined in the form of a force-displacement diagram using standard commercial tablet test devices. For the matter of the present invention, a universal testing machine from Zwick model 1425 was used.

The crushing resistance is determined in accordance with DIN 55526 Part 1 by placing the plastic container vertically between the plates of a pressure testing device and crushing it, the compressive force and the plate travel being recorded until the required crushing resistance and plate travel are achieved or failure arises as a result of critical deformation and/or the container starting to leak.

The compression press was adjusted to a crushing rate of 10 mm/min. The test process was then started. The force [N] exerted at a penetration depth of 22 mm to the portion was printed out on the attached printer. The crushing resistance is given in N. Preference is given here to portioned products according to the invention which are characterized in that the crushing resistance Fₘₐₓ of the product (═Of the filled enclosure) is 20 to 2000 N, preferably 50 to 1000 N, particularly preferably 75 to 600 N, further preferably 100 to 500 N and in particular 150 to 400 N.

The products according to the invention are characterized, as described above, by increased flexibility compared to stiff, rigid hollow bodies. The flexibility and elasticity is expressed in particular in the possibility of reproducible multidetermination in the described mechanical tests, in particular in the determination of the recovery rate.

It is therefore preferred within the scope of the invention that the filled and/or unfilled enclosure, upon n-fold, where n is 2 2, for example 3 or 4, preferably 8, 10, 15 or 20, repetition of the respective measurement of the recovery rate, the deformation work or the crushing resistance on an individual to be tested has a percentage standard deviation, based on the average measurement value, of less than 100%, preferably less than 50%, further preferably less than 40%, particularly preferably less than 30%, in particular less than 20%, particularly preferably less than 10%, most preferably less than 8%, for example less than 5%, advantageously less than 3%, for example less than 2% and extremely preferably less than 1%.

The products according to the invention can be formulated universally for all compositions which can be packaged in water-soluble enclosures. Fields of application are, for example, the preparation of portions of agrochemicals (fertilizers and crop protection agents etc.), foods (“degradable” beverage packaging, packaged foods and food additives etc.), animal feeds, pharmaceuticals, dyes and colorants, adhesives, cosmetics or other industrial fields.

The products according to the invention particularly preferably have the composition of a washing, rinsing or cleaning product. The data below refer to this particularly preferred supply form of the present invention, but applies entirely analogously also for other industrial fields of application.

The enclosure of the washing, rinsing or cleaning products in portions according to the invention is flexible, but nevertheless dimensionally stable. According to the invention, the term “dimensionally stable enclosure” is understood as meaning that the moldings containing the washing product, cleaning product or rinsing product portions have an intrinsic dimensional stability which enables them, under the customary conditions of preparation, storage, transportation and handling by the consumer, to have a non-collapsing structure which is stable against fracture and/or pressure, and which also does not change under said conditions over a prolonged period.

The pressure resistance of the dimensionally stable enclosure according to the invention is measured by sealing enclosures, which are unfilled and optionally provided with compartmentation devices, with films or covers, and applying to these hollow bodies, at room temperature, an internal, constantly rising vacuum until the hollow body starts to collapse. The intrinsic dimensional stability of the hollow bodies should particularly preferably be such that, in such vacuum collapse tests, hollow bodies which are unfilled and optionally provided with compartmentation devices do not start to collapse before a vacuum of 900 mbar, preferably of 750 mbar and in particular of 500 mbar, has been reached. In this regard, the hollow bodies used according to the invention differ fundamentally from films or so-called “pouches”, as are likewise used for the provision of washing products, cleaning products or rinsing products, which collapse even at a pressure which is only slightly below atmospheric pressure. In a similar way, the dimensionally stable hollow bodies according to the invention, however, also differ from coatings (applied subsequently to moldings): the hollow bodies according to the invention represent an independent, self-supporting enclosure which usually exists even prior to filling with one or more washing-active, rinse-active or cleaning-active component(s) and is then filled. In contrast to this, coatings are applied to existing moldings (e.g. compacts, granulates, extrudates etc.) and then dried or cured; only then do they form an enclosure surrounding the molding.

In preferred washing, rinsing or cleaning products in portions according to the invention, the enclosures have a stability in which collapse does not start before a vacuum of 250 mbar, preferably of 100 mbar and in particular of 20 mbar is reached.

Preferred washing, rinsing or cleaning products in portions according to the invention are further characterized in that the wall thickness of the enclosure is 100 to 5000 μm, preferably 200 to 3000 μm, particularly preferably 300 to 2000 μm and in particular 500 to 1500 μm.

The use of polymers as material for the enclosure, which have a flow index (MFI) at the processing temperature below 120, preferably below 50 and in particular below 30, is preferred. The abovementioned MFI values are determined for a weight of 2.16 and 10 kg and are preferably valid for both weights. For the purposes of the present invention, polyvinyl alcohol types which are particularly suitable for injection molding are of low viscosity and have, for example, MFI values of 26-30 (at 190° C., 2.16 kg weight, PVA Texas Polymers, Vinex 2019). For the purposes of the present invention, polyvinyl alcohol grades which are particularly suitable for blow molding are of medium to high viscosity and have, for example, MFI values of 6-8 (at 230° C., 2.16 kg weight, PVA Texas Polymers, Vinex 2034/2144) and 9-11 (at 190° C., 10 kg weight, PVA Texas Polymers, Vinex 5030).

Suitable materials for the enclosure are, in particular, polymers, preference being given to washing, rinsing or cleaning products in portions according to the invention in which the enclosure comprises one or more materials from the group of acrylic acid-containing polymers, polyacrylamides, oxazoline polymers, polystyrenesulfonates, polyurethanes, polyesters and polyethers and mixtures thereof.

Particular preference is given to the use of water-soluble polymers as material for the enclosure. In this connection, washing, rinsing or cleaning products in portions according to the invention have proven useful which are characterized in that the enclosure comprises one or more water-soluble polymer(s), preferably a material from the group of (optionally acetylated) polyvinyl alcohol (PVAL), polyvinylpyrrolidone (PVP), in particular polyvinylpyrrolidone with a molecular weight of from 2500 to 750 000 g/mol, polyethylene oxide, gelatin, cellulose, polyacrylamide, in particular polyacrylamide with a molecular weight of from 5000 to 5 000 000 g/mol, polyethyloxazoline and polymethyloxazoline with a molecular weight of from 5000 to 100 000 g/mol and derivatives thereof and mixtures thereof, further preferably (optionally acetylated) polyvinyl alcohol (PVAL).

For the purposes of the present invention, particular preference is given to polyvinyl alcohols as materials for the enclosure. “Polyvinyl alcohols” (abbreviation PVAL, sometimes PVOH) is here the name for polymers of the general structure

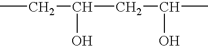

which comprise, in small amounts (about 2%), also structural units of the type

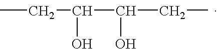

Studied commercial polyvinyl alcohols, which are supplied as white-yellowish powders or granulates with degrees of polymerization in the range from about 100 to 2500 (molar masses of about 4000 to 100 000 g/mol), have degrees of hydrolysis of 98-99 or 87-89 mol %, thus also comprise a residual content of acetyl groups. The polyvinyl alcohols are characterized on the part of the manufacturer by quoting the degree of polymerization, the starting polymer, the degree of hydrolysis, the saponification number and the solution viscosity.

Depending on the degree of hydrolysis, polyvinyl alcohols are soluble in water and a few strongly polar organic solvents (formamide, dimethylformamide, dimethyl sulfoxide); they are not attacked by (chlorinated) hydrocarbons, esters, fats and oils. Polyvinyl alcohols are classified as toxicologically safe and are at least partially biodegradable. The solubility in water can be reduced by after-treatment with aldehydes (acetylation), by complexation with Ni or Cu salts or by treatment with dichromates, boric acid or borax. The coatings of polyvinyl alcohol are largely impenetrable for gases such as oxygen, nitrogen, helium, hydrogen, carbon dioxide, but allow water vapor to pass through.

Washing, rinsing or cleaning products in portions preferred for the purposes of the present invention are characterized in that the enclosure comprises a polyvinyl alcohol whose degree of hydrolysis is 70 to 100 mol %, preferably 80 to 90 mol %, particularly preferably 81 to 89 mol % and in particular 82 to 88 mol %.

Preferably, the materials used for the enclosure are polyvinyl alcohols with a certain molecular weight range, preference being given to washing, rinsing or cleaning products in portions according to the invention in which the enclosure comprises a polyvinyl alcohol whose molecular weight is in the range from 10 000 to 100 000 gmol⁻¹, preferably from 11 000 to 90 000 gmol⁻¹, particularly preferably from 12 000 to 80 000 gmol⁻¹ and in particular from 13 000 to 70 000 gmol⁻¹.

In a preferred embodiment, the water-soluble thermoplast, preferably the polyvinyl alcohol, has a narrow molecular weight distribution, preferably with a distribution quotient of approximately d10/d90<=0.66.

The degree of polymerization of such preferred polyvinyl alcohols is between approximately 200 to approximately 2100, preferably between approximately 220 to approximately 1890, particularly preferably between approximately 240 to approximately 1680 and in particular between approximately 260 to approximately 1500.

The polyvinyl alcohols described above are commercially available, for example under the trade name Mowiol® ex Clariant (included in the Kuraray Specialities Europe KSE). Polyvinyl alcohols which are particularly suitable for the purposes of the present invention are, for example, Mowiol® 3-83, Mowiol® 4-88, Mowiol® 5-88, Mowiol® 8-88 and, in particular, blends or compounds, such as L648, L734, Mowiflex LPTC 221 ex Clariant/KSE, and the compounds from Texas Polymers, such as, for example, Vinex 2034.

Further polyvinyl alcohols which are particularly suitable as material for the hollow bodies are those given in the table below:

| | Degree of | | |
|---|---|---|---|
| | hydrolysis | Molar mass | Melting point |
| Name | [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® | 30-28 | 23 600 | 100 |
| 5407 | | | |
| Gohsefimer ® | 41-51 | 17 700 | 100 |
| LL02 | | | |

Further polyvinyl alcohols which are suitable as material for the hollow shape are ELVANOL® 51-05, 52-22, 50-42, 85-82, 75-15, T-25, T-66, 90-50 (trade name of Du Pont), ALCOTEX® 72.5, 78, B72, F80/40, F88/4, F88/26, F88/40, F88/47 (trade name of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade name of Nippon Gohsei K.K.).

Further polymers which are suitable for the preparation of the enclosure are acrylic acid-containing polymers, such as, for example, copolymers, terpolymers or tetrapolymers which contain at least 20% acrylic acid and have a molecular weight of from 5000 to 500 000 g/mol; as comonomers, particular preference is given to acrylic esters, such as ethyl acrylate, methyl acrylate, hydroxyethyl acrylate, ethylhexyl acrylate, butyl acrylate, and salts of acrylic acid, such as sodium acrylate, methacrylic acid and salts thereof and esters thereof, such as methyl methacrylate, ethyl methacrylate, trimethylammonium methyl methacrylate chloride (TMAEMC), methacrylate amidopropyltrimethylammonium chloride (MAPTAC). Further monomers, such as acrylamide, styrene, vinyl acetate, maleic anhydride, vinylpyrrolidone can likewise be used advantageously.

Polyalkylene oxides, preferably polyethylene oxide with molecular weights of from 600 to 100 000 g/mol and their derivatives modified by graft copolymerization with monomers such as vinyl acetate, acrylic acid and salts thereof and esters thereof, methacrylic acid and salts thereof and esters thereof, acrylamide, styrene, styrene sulfonate and vinylpyrrolidone (example: poly(ethylene glycol-graft-vinyl acetate) are likewise particularly suitable for the preparation of the enclosures according to the invention. The polyglycol fraction should be 5 to 100% by weight, the graft fraction should be 0 to 95% by weight; the latter can consist of one or more monomers. Particular preference is given to a graft fraction of from 5 to 70% by weight; in this connection, the solubility in water decreases with the graft fraction.

Further preferably used polymers are polystyrene sulfonates and copolymers thereof with comonomers such as ethyl (meth)acrylate, methyl (meth)acrylate, hydroxyethyl (meth)acrylate, ethylhexyl (meth)acrylate, butyl (meth)acrylate and the salts of (meth)acrylic acid, such as sodium (meth)acrylate, acrylamide, styrene, vinyl acetate, maleic anhydride, vinylpyrrolidone; the comonomer content should be 0 to 80 mol %, and the molecular weight should be in the range from 5000 to 500 000 g/mol.

Also suitable for the preparation of the enclosures according to the invention are polyurethanes, in particular the reaction products of diisocyanates (e.g. TMXDI) with polyalkylene glycols, in particular polyethylene glycols of molecular weight 200 to 35 000, or with other difunctional alcohols to give products with molecular weights of from 2000 to 100 000 g/mol.

Polyesters with molecular weights of from 4000 to 100 000 g/mol, based on dicarboxylic acids (e.g. terephthalic acid, isophthalic acid, phthalic acid, sulfoisophthalic acid, oxalic acid, succinic acid, sulfosuccinic acid, glutaric acid, adipic acid, sebacic acid etc.) and diols (e.g. polyethylene glycols, for example with molecular weights of from 200 to 35 000 g/mol) are likewise used advantageously for the preparation of enclosures according to the invention, such as cellulose ethers/esters, e.g. cellulose acetates, cellulose butyrates, methylcellulose, hydroxypropylcellulose, hydroxyethylcellulose, methyl-hydroxypropylcellulose or polyvinyl methyl ether with molecular weights of from 5000 to 500 000 g/mol.

Further polymers suitable for the preparation of the enclosures described above are, finally, the graft polymers obtainable by free-radical polymerization of vinyl esters of aliphatic C1-C24-carboxylic acids in the presence of polyethers with an average molecular weight of at least 300 (number-average), for example by free-radical polymerization of vinyl acetate in the presence of polyethylene glycols with a molecular weight of from 500 to 100 000, preferably a molecular weight of from 1000 to 50 000, and hydrolysis from 20 to 100 mol % of the vinyl acetate units of the graft polymers.

The enclosures of the washing, rinsing or cleaning products in portions according to the invention can be prepared by customary processes for the thermoforming of polymers, with deep drawing, so-called rotary-die processes, blow molding (extrusion blowing) and injection molding being of particular importance. The statements which follow emphasize the particularly preferred preparation by injection molding processes, but apply mutatis mutandis also for the other thermoforming processes known from the prior art.

To make the injection molding operation (i.e. their preparation) easier, the hollow bodies may comprise plasticizing auxiliaries. This may be advantageous particularly when the material chosen for the hollow bodies is polyvinyl alcohol or partially hydrolyzed polyvinyl acetate. The content of plasticizing auxiliaries (based on the polymer) is usually up to 15% by weight, preference being given to values between 5 and 10% by weight. Plasticizing auxiliaries which have proven successful are, in particular, glycerol, triethanolamine, ethylene glycol, propylene glycol, diethylene glycol or dipropylene glycol, diethanolamine and methyldiethylamine.

Besides the plasticizing auxiliaries, demolding additives are important auxiliaries which can be used in the injection molding masses. For the purposes of the present invention, from the groups of fatty substances and of finely divided substances, stearic acid and/or stearates, and pyrogenic silicas (Aerosil®), and talc in particular have proven successful. The amount of demolding additives (based on the polymer) is usually up to 5% by weight, values between 0.5 and 2.5% by weight being preferred.

Further substances which can be used as demolding additives originate in particular from the group of fatty substances. For the purposes of this application, fatty substances are understood as meaning substances which are liquid to solid at standard temperature (20° C.) and are from the group of fatty alcohols, fatty acids and fatty acid derivatives, in particular fatty acid esters. For the purposes of the present invention, reaction products of fatty alcohols with alkylene oxides belong to the surfactants (see above) and are not fatty substances within the meaning of the invention. Fatty substances which can be used according to the invention are preferably fatty alcohols and fatty alcohol mixtures, fatty acids and fatty acid mixtures, fatty acid esters with alkanols or diols or polyols, fatty acid amides, fatty amines etc.

The fatty alcohols used are, for example, the alcohols obtainable from native fats and oils: 1-hexanol (caproic alcohol), 1-heptanol (enanthic alcohol), 1-octanol (caprylic alcohol), 1-nonanol (pelargonic alcohol), 1-decanol (capric alcohol), 1-undecanol, 10-undecen-1-ol, 1-dodecanol (lauryl alcohol), 1-tridecanol, 1-tetradecanol (myristyl alcohol), 1-pentadecanol, 1-hexadecanol (cetyl alcohol), 1-heptadecanol, 1-octadecanol (stearyl alcohol), 9-cis-octadecen-1-ol (oleyl alcohol), 9-trans-octadecen-1-ol (erucyl alcohol), 9-cis-octadecen-1,12-diol (ricinol alcohol), all-cis-9,12-octadecadien-1-ol (linoleyl alcohol), all-cis-9,12,15-octadecatrien-1-ol (linolenyl alcohol), 1-nonadecanol, 1-eicosanol (arachidyl alcohol), 9-cis-eicosen-1-ol (gadoleyl alcohol), 5,8,11,14-eicosatetraen-1-ol, 1-heneicosanol, 1-docosanol (behenyl alcohol), 1,3-cis-docosen-1-ol (erucyl alcohol, 1,3-trans-docosen-1-ol (brassidyl alcohol), and mixtures of these alcohols. According to the invention it is also possible to use Guerbet alcohols and oxo alcohols, for example C₁₃₋₁₅-oxo alcohols or mixtures of C₁₂₋₁₈-alcohols with C₁₂₋₁₄ alcohols as fatty substances without problems. It is of course also possible to use alcoholic mixtures, however, for example those such as the C₁₆₋₁₈-alcohols prepared by ethylene polymerization according to Ziegler. Specific examples of alcohols which can be used as component b) are the alcohols already specified above, and lauryl alcohol, palmityl alcohol and stearyl alcohol and mixtures thereof.

Preferred demolding additives here are C₁₀₋₃₀-fatty alcohols, preferably C₁₂₋₂₄-fatty alcohols, particularly preferably 1-hexadecanol, 1-octadecanol, 9-cis-octadecen-1-ol, all-cis-9,12-octadecadien-1-ol, all-cis-9,12,15-octadecatrien-1-ol, 1-docosanol and mixtures thereof.

Fatty acids can also be used as demolding additive. These are obtained industrially in the main from natural fats and oils by hydrolysis. Whereas the alkaline saponification, which was carried out as early as in the 19th century, led directly to the alkali metal salts (soaps), only water is used industrially nowadays for the hydrolysis, which hydrolyzes the fats into glycerol and the free fatty acids. Processes used industrially are, for example, hydrolysis in autoclaves or continuous high-pressure hydrolysis. For the purposes of the present invention, carboxylic acids which can be used as fatty substance are, for example, hexanoic acid (caproic acid), heptanoic acid, (enanthic acid), octanoic acid (caprylic acid), nonanoic acid (pelargonic acid), decanoic acid (capric acid), undecanoic acid etc. For the purposes of the present compound, preference is given to the use of fatty acids, such as dodecanoic acid (lauric acid), tetradecanoic acid (myristic acid), hexadecanoic acid (palmitic acid), octadecanoic acid (stearic acid), eicosanoic acid (arachidic acid), docosanoic acid (behenic acid), tetracosanoic acid (lignoceric acid), hexacosanoic acid (cerotinic acid), triacotanoic acid (melissic acid), and the unsaturated species 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid) and 9c,12c,15c-octadecatrienoic acid (linolenic acid). It is of course also possible to use tridecanoic acid, pentadecanoic acid, margaric acid, nonadecanoic acid, erucic acid, eleostearic acid and arachidonic acid. For reasons of cost, it is preferred to use not the pure species, but technical-grade mixtures of the individual acids, as are accessible from the hydrolysis of fat. Such mixtures are, for example, coconut oil fatty acid (about 6% by weight of C₈, 6% by weight of C₁₀, 48% by weight of C₁₂, 18% by weight of C₁₄, 10% by weight of C₁₆, 2% by weight of C₁₈, 8% by weight of C₁₈, 1% by weight of C_{18″}), palm kernel oil fatty acid (about 4% by weight of C₈, 5% by weight of C₁₀, 50% by weight of C₁₂, 15% by weight of C₁₄, 7% by weight of C₁₆, 2% by weight of C₁₈, 15% by weight of C_{18′}, 1% by weight of C_{18″}), tallow fatty acid (about 3% by weight of C₁₄, 26% by weight of C₁₆, 2% by weight of C_{16′}, 2% by weight of C₁₇, 17% by weight of C_{18″}, 44% by weight of C_{18′}, 3% by weight of C₁₈, 1% by weight of C_{18′″}), hydrogenated tallow fatty acid (about 2% by weight of C₁₄, 28% by weight of C₁₆, 2% by weight of C₁₇, 63% by weight of C₁₈, 1% by weight of C_{18′}), technical-grade oleic acid (about 1% by weight of C₁₂, 3% by weight of C₁₄, 5% by weight of C₁₆, 6% by weight of C_{16′}, 1% by weight of C₁₇, 2% by weight of C₁₈, 70% by weight of C_{18′}, 10% by weight of C_{18″}, 0.5% by weight of C_{18′″}), technical-grade palmitic/stearic acid (about 1% by weight of C₁₂, 2% by weight of C₁₄, 45% by weight of C₁₆, 2% by weight of C₁₇, 47% by weight of C₁₈, 1% by weight of C₁₈′), and soybean oil fatty acid (about 2% by weight of C₁₄, 15% by weight of C₁₆, 5% by weight of C₁₈, 25% by weight of C_{18′}, 45% by weight of C_{18′}, 7% by weight of C_{18′″}).

Fatty acid esters which can be used are the esters of fatty acids with alkanols, diols or polyols, preference being given to fatty acid polyol esters. Suitable fatty acid polyol esters are monoesters and diesters of fatty acids with certain polyols. The fatty acids which are esterified with the polyols are preferably saturated or unsaturated fatty acids having 12 to 18 carbon atoms, for example lauric acid, myristic acid, palmitic acid or stearic acid, preference being given to using the mixtures of fatty acids which are produced industrially, for example the acid mixtures derived from coconut fat, palm kernel fat or tallow fat. In particular, acids or mixtures of acids having 16 to 18 carbon atoms, such as, for example, tallow fatty acid, are suitable for esterification with the polyhydric alcohols. For the purposes of the present invention, suitable polyols which are esterified with the abovementioned fatty acids are sorbitol, trimethylolpropane, neopentyl glycol, ethylene glycol, polyethylene glycols, glycerol and polyglycerols.

Preferred embodiments of the present invention intend that glycerol is used as the polyol which is esterified with fatty acid(s). Consequently, fatty substances from the group of fatty alcohols and fatty acid glycerides are preferred as demolding additives. Particularly preferred demolding additives are fatty substances from the group of fatty alcohols and fatty acid monoglycerides. Examples of such preferably used fatty substances are glycerol monostearic esters and glycerol monopalmitic esters.

In order to prevent undesired changes caused by the effect of oxygen and other oxidative processes on the injection molding masses, they may comprise antioxidants. This class of compound includes, for example, substituted phenols, hydroquinones, pyrocatechins and aromatic amines, and also organic sulfides, polysulfides, dithiocarbamates, phosphites and phosphonates.

The present application further provides an extrusion blowing process for the preparation of enclosures according to the invention.

If the enclosures according to the invention are prepared by extrusion blowing, then, depending on the process control and process conditions, extrusion-blown residues may be produced in the processes according to the invention which, depending on the shape and configuration of the extrusion-blown bodies formed from one or more sections, can be produced to differing levels. Extrusion-blown residues are generally residues of the premolding which were not used for the blow molding of the hollow body and were separated as a result of the sealing of the blow-molded hollow body and/or stamping and/or cutting out of the blow-molded body from the premolding. It has been found that the blow-molded residues can be reused and can be returned to the process for the preparation of the blow-molded bodies.

Such blow-molded residues are preferably recycled and thus returned to the original process. The blow-molded residues consisting of water-soluble polymeric thermoplasts are captured, optionally collected, and added to the original blow-molding process. The blow-molding residues can, depending on the process condition prior to their return to the preparation process of the blow-molded bodies, be supplied with additional components, for example those which are lost from the original blow-molding mass as a result of the thermal treatment and are now missing from the polymer mass of the blow-molding residues. Additional added components are, for example, water or plasticizer components. Preferably, the optionally additionally supplied blow-molding residues are mixed with the originally used blow-molding mass, preferably with the fresh polymer (compound) granulate prior to the melting, and then introduced into the process. In this connection, it may be particularly preferred to establish a stationary mixing ratio of fresh to recycled granulate in continuous operation to correspond to the recyclate reflux which arises. It may, however, also be preferred to switch between the operation with non-mixed fresh polymer (compound) granulate and that with combined recyclate at particular time intervals.

It has proven to be particularly advantageous to firstly comminute the blow-molded residues prior to their recycle to the process. Suitable devices for the comminution of polymer residues are for example, cutting mills, as can be obtained from Pallmann, Zweibrucken.

The transportation of the blow-molded residues to the comminution station and/or to the mixer in which optionally comminuted blow-molded residues are mixed with original blow-molding mass, which is present, for example, in the form of a polymer granulate or compound, and/or to the extruder, by means of which premoldings can again be formed from blow-molding residue and original blow-molding mass, take place via devices familiar to the person skilled in the art, preferably by means of conveyor belts, conveyor screws or by pneumatically operated pipe systems.

The description regarding the recycling of polymeric production waste explained above by reference to the extrusion blowing process should, however, not be limited to this preparation process for enclosures according to the invention which is also particularly preferred for the purposes of the invention besides the injection molding process, but is to refer analogously also to the recycling of residues and/or waste material of other preparation processes, such as, for example, to all thermoforming processes, in particular deep drawing, with water-soluble films.

In a further preferred embodiment of the preparation process, preferably, but not limited to, extrusion blowing and/or injection molding and/or thermoforming processes, the liquid-tight sealing of the hollow body is followed by an additional detection step for leaks. Particularly in the case of industrial application with a high product throughput, it is advantageous to check the filled hollow bodies directly after their production for leaks in order to avoid the contamination of further filled hollow bodies which may be located in the same outer packaging as the damaged hollow body, and to ensure quality assurance. A purely visual assessment of the prepared hollow bodies is in principle possible, but from an economic point of view, particularly in the case of industrial production with a high product throughput, offers few advantages since it is very labor-intensive. Electronic detection systems for leaks have proven particularly advantageous. A particularly suitable detection system for determining leaks in hollow bodies which are particularly preferably blow-molded and filled particularly with liquids, is the high-voltage leak detector (HVLD detector) sold by Rommelag. The detection method is based on the electrical conductivity of the fill material which is surrounded by a polymer which is non-conductive or only weakly conductive. If a leak is present, then the discharge current flows through the leak opening into the hollow body, and detection of this current leads to discharge of the damaged, filled hollow body. Suitable detectors are, for example, HVLD 923 and HVLD 924 ex Rommelag.

A critical point in connection with thermoplastic preparation processes, preferably, but not limited to, extrusion blowing and/or injection molding, is, in the case of processing water-soluble polymers, in particular of polyvinyl alcohol, polyvinyl acetate or partially hydrolyzed polyvinyl acetate, the melting and the associated introduction of mechanical and thermal energy into the polymer material to be processed. The melt operation of the polymer materials does not take place at a defined melting point, but over a relatively long melting range. Depending on the polymer and crystalline properties of the polymer, the upper limit of the melting range can be so high that the crystals can only melt with difficulty in an extruder since non-molten crystallites presumably form a particle stream. The appearance of crystals in the polymer melts can lead to faults during the processing of such polymers, for example specks in the container walls. An increased input of thermal energy during the extrusion process in order to completely melt the crystals which remain in the melt can easily lead to the formation of a decomposing or crosslinking material, in which case the material then has specks which are similar to the structure of the specks which are of crystalline origin, the only difference, however, being the presence of a chemical bond instead of a physical bond. Increased crosslinking of the polymer material leads to a considerable change in the physical properties, in particular this may lead to a change in the elasticity of the polymer material in the final product or to poorer solubility in water. The use of external plasticizers may contribute to overcoming the described problem, but the use of such plasticizer auxiliaries is also limited with regard to their use amount. An increased use of plasticizer components can, for example, lead to the stickiness of the objects produced, which in turn are then of lower or no commercial value.

To solve the problem, in an advantageous process, the polymer is melted such that an excessive input of energy is avoided which would lead to decomposition of the material. In particular, the input both of thermal and also mechanical energy is advantageous. The additional input of mechanical energy leads to the areas of crystallinity being subjected to shearing, where at the same time this shear energy can be dissipated or the input of thermal energy is reduced in order to prevent the melting temperature exceeding the decomposition temperature. The additional energy which is introduced for carrying out the shearing passes through the melt, the crystallinity being eliminated, and is dissipated in a further advantageous embodiment by cooling the melt, for example by a cooling jacket of the extruder.

The requirements for the extruder in a preferred embodiment are, in particular, that it has intensive mixing elements so that the required shear energy can be provided.

The extruder can optionally dissipate the excess energy introduced which is required upon heating, melting or shearing the polymer. This energy excess can, for example, be dissipated through the extruder housing, the extruder screw or by evaporation of the plasticizer in the step involving removal of the volatile constituents.

In a preferred thermoplastic preparation process, preferably, but not limited to, extrusion blowing and/or injection molding, the extruder mixing the melt is operated with a high rotary screw speed, preferably above 10 revolutions per minute, particularly preferably above 20 revolutions per minute, especially preferably above 70 revolutions per minute, most preferably above 150 revolutions per minute, especially above 300 revolutions per minute, for example 400, 500 or 600 revolutions per minute. In addition, the extruder can be operated with a number of intensively kneading elements in line with the design of the screw so that the required mechanical energy input arises. The screw housing can also be operated at a temperature below the melting temperature of the polymer meaning that there is no net transfer of heat from the extruder. The result is a high degree of input of mechanical energy into the polymer, which is sufficient to eliminate specks or crystalline sections of the polymer melt by displacing all of the crystalline regions from one another.

A high input of kinetic energy into the polymer mass has proven to be advantageous. Within the scope of the invention, a high apparent wall shear rate is particularly preferred. The shear rate is usually given as the angle rate ω(t) (derivation of the angle of rotation γ(t) according to time t) and expresses the ratio of the rate difference δv (delta v) of two layers flowing past one another to their distance δh (delta h) perpendicular to the direction of flow. In a preferred embodiment, the shear rate in the extruder and optionally on the blow head is above 1 s⁻¹, preferably above 2 s⁻¹, further preferably above 3 s⁻¹, in particular above 5 s⁻¹, particularly preferably above 8 s⁻¹, further preferably above 10 s⁻¹, even more preferably above 20 s⁻¹, yet further above 40 s⁻¹, most preferably above 60 s⁻¹, advantageously above 100 s⁻¹, and particularly advantageously above 200 s⁻.

Usually, the shear rates at nozzle devices, such as, for example, the blowing nozzle and/or the injection molding nozzle, are higher than at other components of the extruder. The shear rate at nozzle devices is above 1 s⁻¹, preferably above 2 s⁻¹, further preferably above 3 s⁻¹, in particular above 5 s⁻¹, particularly preferably above 8 s⁻¹, further preferably above 10 s⁻¹, yet further preferably above 20 s⁻¹, further still above 40 s⁻¹, most preferably above 60 s⁻¹, advantageously above 100 s-1 and particularly advantageously above 200 s⁻¹, for example above 500 s⁻¹, 1000 s⁻¹, 2000 s⁻¹ or 4000 s⁻¹.

A low residence time of the polymer material in the extruder is particularly advantageous in order to reduce the heat course. Suitable residence times are less than one hour, preferably less than 30 minutes, particularly preferably less than 20 minutes, extremely preferably less than 10 minutes and in particular less than 5 minutes.

It is particularly advantageous, in the case of the configuration of the flow control of the thermoplastic melt in the extruder and optionally at the blow head, to ensure that any dead zones in the flow are avoided and ideally a narrow residence time distribution breadth, particularly preferably as plug flow, are desired. This measure should prevent, in individual areas, only partial volumes of the thermoplasts put through in total, in the form of dammed or back-flowing material, are also exposed to excessively long thermal exposure, with the known disadvantages. Suitable measures may consist in a suitable extruder design and/or in flow channel inside walls and junctions extended continuously and/or in a rounded manner and/or without stepping, or tapered.

It is therefore preferred that the extruder screw and optionally hose head devices have essentially no dead zones and/or essentially no backflow arises.

A preferred standard commercial device is the twin-screw extruder from Werner und Pfleiderer, which is a simultaneously rotating, completely intermeshing extruder. The screw is designed in segments so that a number of different screw elements can be arranged on splined shafts, thereby achieving the degree of mixing desired for the particular application. The screw elements can vary along the screw, two screws must, however, fit together so that completely intermeshing surfaces are achieved. Generally speaking, there are two different types of element, screw conveying elements and kneading or mixing discs. The screw elements can either have a forwards directed or negative pitch, whereas the kneading discs can have a neutral pitch in addition to the forwards directed or negative pitch. The kneading discs consist of stacked elliptical discs which are displaced so that an overall conveying pitch is achieved. The width of the discs can vary from one element to the next, although the discs are of the same width within one element. In addition to the changed pitch in the kneading blocks, different screw elements can have different conveying pitches. The person skilled in the art can arrange suitable screws so that the optimum shear course and the optimum conveying effect is achieved, which lead to the desired end product.

Furthermore, the wider the kneading disc, the more considerable the shear which is imparted to the melt. The narrower the screw thread, the more shear is transferred. All of these factors can be combined by the person skilled in the art to configure a screw which achieves maximum shear transfer without thermal decomposition and the after-crosslinking of the product often associated with it.

Particularly for the case when possibly occurring blow-molding residues or polymeric production waste are to be recycled, the lowest possible thermally-induced degree of after-crosslinking is desired. Since the residues in some instances have to pass several times through the extrusion melt process, it has proven advantageous for the purposes of the present invention that the degree of after-crosslinking of the polymer used is so low that it can be recycled up to ten times. The degree of after-crosslinking can be determined by reference to the average molecular weight of the polymer. The higher the degree of after-crosslinking caused by extrusion and melt, the higher the increase in the average molecular weight of the polymer as well. In a preferred process, the increase in the average molecular weight of the water-soluble polymeric thermoplasts is less than 15%, preferably less than 10%, particularly preferably less than 8%, most preferably less than 5%, particularly less than 2%, in the case of a single pass through the extrusion process. The average molecular weight of the polymers, in particular of partially hydrolyzed polyvinyl acetate, was determined by means of gel permeation chromatography.

In the case of preferred washing, rinsing or cleaning products in portions according to the invention, the material for the enclosure, the wall thickness and the size of the enclosure are chosen such that the enclosure dissolves and releases the filling ingredients in unagitated water at 20° C. in less than 300 seconds, preferably in less than 60 seconds. In this connection, it is not necessary for the entire molding to dissolve spontaneously. Rather, it suffices if all of the constituents dissolve within the application period under the application conditions. For customary washing or rinsing processes, this means temperatures of 20° C. and above, mechanical action, and times of less than 200 minutes, preferably less than 60 minutes, in particular less than 20 minutes. However, the ingredients of at least one compartment should be released in less than 300 seconds, in particular in less than 60 seconds. This can take place through the use of disintegration auxiliaries, through the sealing of a compartment with a thin, water-soluble film, through dissolution of a “stopper” which seals an opening, or in another customary manner.

The washing, rinsing or cleaning products in portions according to the invention can be realized particularly advantageously when the fraction of water-soluble polymers in the enclosure is high. Preferably, the entire enclosure consists only of the water-soluble polymers and optionally auxiliaries (see above). Preference is given here to washing, rinsing or cleaning products in portions according to the invention in which the enclosure comprises said polymers in amounts of at least 50% by weight, preferably of at least 70% by weight, particularly preferably of at least 80% by weight and especially of at least 90% by weight, in each case based on the total weight of the enclosure.

The washing, rinsing or cleaning products in portions according to the invention can be formulated as washing products, as cleaning products or as rinsing products depending on which ingredients are surrounded by the enclosure. Besides textile washing products, it is, for example, possible to prepare cleaning products for machine or manual dish washing, universal household cleaners, WC cleaners, glass cleaners etc. The choice of ingredients in the washing, rinsing or cleaning product compositions present within the enclosure can be different depending on the intended use. Important ingredients of these compositions are described below.

The washing, rinsing or cleaning product compositions preferably comprise surfactant(s), where anionic, nonionic, cationic and/or amphoteric surfactants are used. From a performance point of view, for textile washing products, preference is given to mixtures of anionic and nonionic surfactants, where the fraction of anionic surfactant should be greater than the fraction of nonionic surfactants. The total surfactant content of the washing, rinsing or cleaning product composition is preferably less than 30% by weight, based on the total product.

The nonionic surfactants used are preferably alkoxylated, advantageously ethoxylated, in particular primary alcohols having preferably 8 to 18 carbon atoms and on average 1 to 12 mol of ethylene oxide (EO) per mole of alcohol, in which the alcohol radical may be linear or preferably methyl-branched in the 2 position, or may contain linear and methyl-branched radicals in the mixture, as are usually present in oxo alcohol radicals. In particular, however, preference is given to alcohol ethoxylates with linear radicals of alcohols of natural origin having 12 to 18 carbon atoms, e.g. from coconut alcohol, palm alcohol, tallow fatty alcohol or oleyl alcohol, and on average 2 to 8 EO per mole of alcohol. Preferred ethoxylated alcohols include, for example, C₁₂₋₁₄-alcohols with 3 EO, 4 EO or 7 EO, C₉₋₁₁-alcohol with 7 EO, C₁₃₋₁₅-alcohols with 3 EO, 5 EO, 7 EO or 8 EO, C₁₂₋₈-alcohols with 3 EO, 5 EO or 7 EO and mixtures of these, such as mixtures of C₁₂₋₁₄-alcohol with 3 EO and C₁₂₋₁₈-alcohol with 7 EO. The stated degrees of ethoxylation represent statistical average values which, for a specific product, may be an integer or a fraction. Preferred alcohol ethoxylates have a narrowed homolog distribution (narrow range ethoxylates, NRE). In addition to these nonionic surfactants, it is also possible to use fatty alcohols with more than 12 EO. Examples thereof are tallow fatty alcohol with 14 EO, 25 EO, 30 EO or 40 EO. Nonionic surfactants which contain EO and PO groups together in the molecule can also be used according to the invention. In this connection, it is possible to use block copolymers with EO-PO block units or PO-EO block units, but also EO-PO-EO copolymers and PO-EO-PO copolymers. It is of course also possible to use mixed alkoxylated nonionic surfactants in which EO and PO units are distributed not blockwise, but randomly. Such products are obtainable by simultaneous action of ethylene oxide and propylene oxide on fatty alcohols.

Furthermore, further nonionic surfactants which may be used are also alkyl glycosides of the general formula RO(G)ₓ, in which R is a primary straight-chain or methyl-branched, in particular methyl-branched in the 2 position, aliphatic radical having 8 to 22, preferably 12 to 18, carbon atoms, and G is the symbol which stands for a glycose unit having 5 or 6 carbon atoms, preferably glucose. The degree of oligomerization x, which gives the distribution of monoglycosides and oligoglycosides, is any desired number between 1 and 10; preferably x is 1.2 to 1.4.

A further class of preferably used nonionic surfactants, which are used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain, in particular fatty acid methyl esters.

Nonionic surfactants of the amine oxide type, for example N-cocoalkyl-N,N-dimethylamine oxide and N-tallow-alkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

Further suitable surfactants are polyhydroxy fatty acid amides of the formula I,

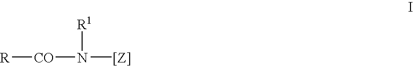

in which RCO is an aliphatic acyl radical having 6 to 22 carbon atoms, R¹ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which are customarily obtained by reductive amination of a reducing sugar with ammonia, an alkylamine or an alkanolamine, and subsequent acylation with a fatty acid, a fatty acid alkyl ester or a fatty acid chloride.

The group of polyhydroxy fatty acid amides also includes the compounds of the formula II,

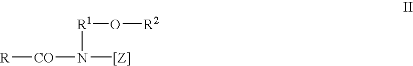

in which R is a linear or branched alkyl or alkenyl radical having 7 to 12 carbon atoms, R¹ is a linear, branched or cyclic alkyl radical or an aryl radical having 2 to 8 carbon atoms, and R² is a linear, branched or cyclic alkyl radical or an aryl radical or an oxy-alkyl radical having 1 to 8 carbon atoms, where C₁₋₄-alkyl or phenyl radicals are preferred and [Z] is a linear polyhydroxyalkyl radical whose alkyl chain is substituted by at least two hydroxyl groups, or alkoxylated, preferably ethoxylated or propoxylated derivatives of this radical.

[Z] is preferably obtained by reductive amination of a sugar, for example glucose, fructose, maltose, lactose, galactose, mannose or xylose. The N-alkoxy- or N-aryloxy-substituted compounds may then be converted into the desired polyhydroxy fatty acid amides by reaction with fatty acid methyl esters in the presence of an alkoxide as catalyst.

The content of nonionic surfactants in preferred washing, rinsing or cleaning product compositions in portions according to the invention suitable for textile washing is 5 to 20% by weight, preferably 7 to 15% by weight and in particular 9 to 14% by weight, in each case based on the total product.

In machine dishwashing products, preference is given to using low-foaming nonionic surfactants. Machine dishwashing products according to the invention advantageously comprise a nonionic surfactant which has a melting point above room temperature. Accordingly, preferred products are characterized in that they comprise nonionic surfactant(s) with a melting point above 20° C., preferably above 25° C., particularly preferably between 25 and 60° C. and in particular between 26.6 and 43.3° C.

Suitable nonionic surfactants which have melting points or softening points within the stated temperature range are, for example, low-foaming nonionic surfactants which may be solid or highly viscous at room temperature. If nonionic surfactants which are highly viscous at room temperature are used, then it is preferred that they have a viscosity above 20 Pas, preferably above 35 Pas and in particular above 40 Pas. Nonionic surfactants which have a wax-like consistency at room temperature are also preferred.

Preferred nonionic surfactants that are solid at room temperature originate from the groups of alkoxylated nonionic surfactants, in particular ethoxylated primary alcohols and mixtures of these surfactants with surfactants of more complex structure, such as polyoxypropylene/polyoxyethylene/polyoxypropylene (PO/EO/PO) surfactants. Such (PO/EO/PO) nonionic surfactants are characterized, moreover, by good foam control.

In a preferred embodiment of the present invention, the nonionic surfactant with a melting point above room temperature is an ethoxylated nonionic surfactant originating from the reaction of monohydroxyalkanol or alkylphenol having 6 to 20 carbon atoms with preferably at least 12 mol, particularly preferably at least 15 mol, in particular at least 20 mol, of ethylene oxide per mole of alcohol or alcohol phenol.

A particularly preferred nonionic surfactant that is solid at room temperature is obtained from a straight-chain fatty alcohol having 16 to 20 carbon atoms (C₁₆₋₂₀-alcohol), preferably a C₁₈-alcohol and at least 12 mol, preferably at least 15 mol and in particular at least 20 mol, of ethylene oxide. Of these, the so-called “narrow range ethoxylates” (see above) are particularly preferred.

Accordingly, particularly preferred products according to the invention comprise ethoxylated nonionic surfactant(s) which has/have been obtained from C₆₋₂₀-monohydroxyalkanols or C₆₋₂₀-alkylphenols or C₁₆₋₂₀-fatty alcohols and more than 12 mol, preferably more than 15 mol and in particular more than 20 mol, of ethylene oxide per mole of alcohol.

The nonionic surfactant preferably additionally has propylene oxide units in the molecule. Preferably, such PO units account for up to 25% by weight, particularly preferably up to 20% by weight and in particular up to 15% by weight, of the overall molar mass of the nonionic surfactant. Particularly preferred nonionic surfactants are ethoxylated monohydroxyalkenols or alkylphenols which additionally have polyoxyethylene-polyoxypropylene block copolymer units. The alcohol or alkylphenol moiety of such nonionic surfactant molecules constitutes preferably more than 30% by weight, particularly preferably more than 50% by weight and in particular more than 70% by weight, of the total molar mass of such nonionic surfactants. Preferred rinse aids are characterized in that they comprise ethoxylated and propoxylated nonionic surfactants in which the propylene oxide units in the molecule constitute up to 25% by weight, preferably up to 20% by weight and in particular up to 15% by weight, of the total molar mass of the nonionic surfactant.

Further particularly preferred nonionic surfactants with melting points above room temperature comprise 40 to 70% of a polyoxypropylene/polyoxyethylene/-polyoxypropylene block polymer blend, which comprises 75% by weight of an inverted block copolymer of polyoxy-ethylene and polyoxypropylene with 17 mol of ethylene oxide and 44 mol of propylene oxide and 25% by weight of a block copolymer of polyoxyethylene and polyoxypropylene, initiated with trimethylolpropane and containing 24 mol of ethylene oxide and 99 mol of propylene oxide per mole of trimethylolpropane.

Nonionic surfactants which may be used with particular preference are available, for example, under the name Poly Tergent® SLF-18 from Olin Chemicals.

A further preferred washing, rinsing or cleaning product in portions according to the invention comprises nonionic surfactants of the formula

R¹ o[CH₂CH(CH₃)O]ₓ[CH₂CH₂O]_{y}[CH₂CH(OH)R²],

in which R¹ is a linear or branched aliphatic hydrocarbon radical having 4 to 18 carbon atoms or mixtures thereof, R² is a linear or branched hydrocarbon radical having 2 to 26 carbon atoms or mixtures thereof, and x is values between 0.5 and 1.5, and y is a value of at least 15.

Further preferred nonionic surfactants are the terminally capped poly(oxyalkylated) nonionic surfactants of the formula

R¹O [CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is values between 1 and 30, k and j represent values between 1 and 12, preferably between 1 and 5. If the value x is ≧2, each R³ in the above formula may be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the radical R³, H, —CH₃ or —CH₂CH₃ are particularly preferred. Particularly preferred values for x are in the range from 1 to 20, in particular from 6 to 15.

As described above, each R³ in the above formula may be different if x is ≧2. By this means it is possible to vary the alkylene oxide unit in the square brackets. If x, for example, is 3, the radical R³ may be chosen in order to form ethylene oxide (R³═H) or propylene oxide (R³═CH₃) units, which may be added onto one another in any sequence, for example (EO) (PO) (EO), (EO) (EO) (PO), (EO) (EO) (EO), (PO) (EO) (PO), (PO) (PO) (EO) and (PO) (PO) (PO). The value 3 for x has been chosen here by way of example and it is entirely possible for it to be larger, the scope of variation increasing with increasing values of x and embracing, for example, a large number of (EO) groups; combined with small number of (PO) groups, or vice versa.

Particularly preferred terminally capped poly(oxyalkylated) alcohols of the above formula have values of k=1 and j=1, thereby simplifying the above formula to

R¹O[CH₂CH(R³)O]ₓCH₂CH(OH)CH₂OR²

In the last-mentioned formula, R¹, R² and R³ are as defined above and x stands for numbers from 1 to 30, preferably from 1 to 20 and in particular from 6 to 18. Particular preference is given to surfactants in which the radicals R¹ and R² have 9 to 14 carbon atoms, R³ is H, and x assumes values from 6 to 15.

Summarizing the statements given last, preference is given to washing, rinsing or cleaning products in portions according to the invention which contain terminally capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is values between 1 and 30, k and j are values between 1 and 12, preferably between 1 and 5, where surfactants of the type

R¹O[CH₂CH(R³)O]ₓCH₂CH(OH)CH₂OR²

in which x represents numbers from 1 to 30, preferably from 1 to 20 and in particular from 6 to 18, are particularly preferred.

Anionic, cationic and/or amphoteric surfactants can also be used in conjunction with said surfactants; due to their foaming behavior in machine dishwashing products, they are only of minor importance and are mostly used only in amounts below 10% by weight, in most cases even below 5% by weight, for example from 0.01 to 2.5% by weight, in each case based on the product. The products according to the invention can thus also comprise anionic, cationic and/or amphoteric surfactants as surfactant component.

As cationic active substances, the products according to the invention can, for example, comprise cationic compounds of the formula III, IV or V:

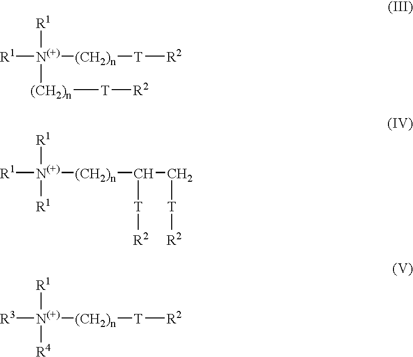

in which each group R¹, independently of the others, is chosen from C₁₋₆-alkyl, -alkenyl or -hydroxyalkyl groups; each group R², independently of the others, is chosen from C₈₋₂₈-alkyl or -alkenyl groups; R³═R¹ or (CH₂)ₙ-T-R²; R⁴═R¹ or R² or (CH₂)ₙ-T-R²; T=—CH₂—, —O—CO— or —CO—O— and n is an integer from 0 to 5.

The anionic surfactants used are, for example, those of the sulfonate and sulfate type. Suitable surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁8-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination of sulfoxidation with subsequent hydrolysis or neutralization, respectively. The esters of α-sulfo fatty acids (ester sulfonates), e.g. the α-sulfonated methyl esters of hydrogenated coconut, palm kernel or tallow fatty acids are also likewise suitable.

Further suitable anionic surfactants are sulfated fatty acid glycerol esters. Fatty acid glycerol esters are understood as meaning the mono-, di- and triesters, and mixtures thereof, as are obtained in the preparation by esterification of a monoglycerol with 1 to 3 mol of fatty acid or in the transesterification of triglycerides with 0.3 to 2 mol of glycerol. Preferred sulfated fatty acid glyceryl esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal, and in particular the sodium, salts of the sulfuric half-esters of C₁₂-C₁₈-fatty alcohols, for example from coconut fatty alcohol, tallow fatty alcohol, lauryl alcohol, myristyl alcohol, cetyl alcohol or stearyl alcohol or of C₁₀-C₂₀-oxo alcohols and those half-esters of secondary alcohols with this chain length. In addition, preference is given to alk(en)yl sulfates of stated chain length which contain a synthetic straight-chain alkyl radical prepared on a petrochemical basis and which have analogous degradation behavior to the equivalent compounds based on fatty chemical raw materials. From the point of view of washing, preference is given to the C₁₂-C₁₆-alkyl sulfates and C₁₂-C₁₅-alkyl sulfates, and to C₁₄-C₁₅-alkyl sulfates. 2,3-alkyl sulfates, which are prepared, for example, in accordance with US patent specifications U.S. Pat. No. 3,234,258 or U.S. Pat. No. 5,075,041 and can be obtained as commercial products from Shell Oil Company under the name DAN®, are also suitable anionic surfactants.

The sulfuric monoesters of straight-chain or branched C₇-C₂₁-alcohols ethoxylated with 1 to 6 mol of ethylene oxide, such as 2-methyl-branched C₉-C₁₁-alcohols having on average 3.5 mol of ethylene oxide (EO) or C₁₂-C₁₈-fatty alcohols having 1 to 4 EO, are also suitable. Due to their high foaming behavior, they are used in cleaning products only in relatively small amounts, for example in amounts of from 1 to 5% by weight.

Further suitable anionic surfactants are also the salts of alkylsulfosuccinic acid, which are also referred to as sulfosuccinates or as sulfosuccinic esters, and which represent monoesters and/or diesters of sulfosuccinic acid with alcohols, preferably fatty alcohols and in particular ethoxylated fatty alcohols. Preferred sulfosuccinates contain C₈₋₁₈-fatty alcohol radicals or mixtures of these. Particularly preferred sulfosuccinates contain a fatty alcohol radical derived from ethoxylated fatty alcohols which, viewed per se, represent nonionic surfactants (description see below). In this connection, particular preference is in turn given to sulfosuccinates whose fatty alcohol radicals are derived from ethoxylated fatty alcohols with a narrowed homolog distribution. It is likewise also possible to use alk(en)ylsuccinic acid having preferably 8 to 18 carbon atoms in the alk(en)yl chain or salts thereof.

Suitable further anionic surfactants are, in particular, soaps. Saturated and unsaturated fatty acid soaps, such as the salts of lauric acid, myristic acid, palmitic acid, stearic acid, (hydrogenated) erucic acid and behenic acid, and in particular soap mixtures derived from natural fatty acids, e.g. coconut, palm kernel, olive oil or tallow fatty acids, are suitable.

The anionic surfactants including the soaps can be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts.

The content of anionic surfactants in preferred textile washing products according to the invention is 5 to 25% by weight, preferably 7 to 22% by weight and in particular 10 to 20% by weight, in each case based on the total product.

For the purposes of the present invention, preferred products additionally comprise one or more substances from the group of builders, bleaches, bleach activators, enzymes, electrolytes, nonaqueous solvents, pH extenders, fragrances, perfume carriers, fluorescent agents, dyes, hydrotopes, foam inhibitors, silicone oils, anti-redeposition agents, optical brighteners, graying inhibitors, shrink preventatives, anticrease agents, dye-transfer inhibitors, antimicrobial active ingredients, germicides, fungicides, antioxidants, corrosion inhibitors, antistats, easy-iron agents, repellant and impregnation agents, swelling and nonslip agents, and UV absorbers.

Builders which may be present in the products according to the invention are, in particular phosphates, silicates, aluminum silicates (in particular zeolites), carbonates, salts of organic di- and polycarboxylic acids, and mixtures of these substances.

The use of the generally known phosphates as builder substances is possible according to the invention provided such a use is not to be avoided for ecological reasons. Among the numerous commercially available phosphates, the alkali metal phosphates, particularly preferably pentasodium and pentapotassium triphosphate (sodium or potassium tripolyphosphate), are of greatest importance in the washing and cleaning product industry.

Alkali metal phosphates is the collective term for the alkali metal (especially sodium and potassium) salts of the various phosphoric acids, among which metaphosphoric acids (HPO₃)ₙ and orthophosphoric acid H₃PO₄, in addition to higher molecular weight representatives, may be distinguished. The phosphates combine a number of advantages: they act as alkali carriers, prevent limescale films on machine components, and lime encrustations in fabrics, and additionally contribute to the cleaning performance.

Sodium dihydrogenphosphate, NaH₂PO₄, exists as the dihydrate (density 1.91 gcm⁻³, melting point 600) and as the monohydrate (density 2.04 gcm⁻³). Both salts are white powders of very ready solubility in water which lose the water of crystallization upon heating and undergo transition at 200° C. to the weakly acidic diphosphate (disodium hydrogendiphosphate, Na₂H₂P₂O₇), and at the higher temperature to sodium trimetaphosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogenphosphate (primary or monobasic potassium phosphate, potassium biphosphate, KDP), KH₂PO₄, is a white salt with a density of 2.33 gcm⁻³, has a melting point of 253° [decomposition with formation of potassium polyphosphate (KPO₃)ₓ] and is readily soluble in water.

Disodium hydrogenphosphate (secondary sodium phosphate), Na₂HPO₄, is a colorless crystalline salt which is very readily soluble in water. It exists in anhydrous form and with 2 mol (density 2.066 gcm⁻³, water loss at 95°), 7 mol (density 1.68 gcm³, melting point 48° with loss of 5H₂O) and 12 mol of water (density 1.52 gcm⁻³, melting point 35° with loss of 5H₂O), becomes anhydrous at 100° and, if heated more severely, undergoes transition to the diphosphate Na₄P₂O₇. Disodium hydrogenphosphate is prepared by neutralizing phosphoric acid with sodium carbonate solution using phenolphthalein as indicator. Dipotassium hydrogenphosphate (secondary or dibasic potassium phosphate), K₂HPO₄, is an amorphous white salt which is readily soluble in water.

Trisodium phosphate, tertiary sodium phosphate, Na₃PO₄, are colorless crystals which, in the form of the dodecahydrate, have a density of 1.62 gcm⁻³ and a melting point of 73-76° C. (decomposition), in the form of the decahydrate (corresponding to 19-20% P₂O₅) have a melting point of 100° C., and in anhydrous form (corresponding to 39-40% P₂O₅) have a density of 2.536 gcm⁻³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent, granular powder of density 2.56 gcm³, has a melting point of 1340° and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the cleaning products industry over the corresponding sodium compounds.

Tetrasodium diphosphate (sodium pyrophosphate), Na₄P₂O₇, exists in anhydrous form (density 2.534 gcm⁻³, melting point 988°, 880° also reported) and in the form of the decahydrate (density 1.815-1.836 gcm³, melting point 940 with loss of water). Both substances are colorless crystals which dissolve in water with an alkaline reaction. Na₄P₂O₇ is formed when disodium phosphate is heated to >200° or by reacting phosphoric acid with sodium carbonate in stoichiometric ratio and removing the water from the solution by spraying. The decahydrate complexes heavy metal salts and hardness formers and therefore reduces the hardness of water. Potassium diphosphate (potassium pyrophosphate), K₄P₂O₇, exists in the form of the trihydrate and is a colorless, hygroscopic powder of density 2.33 gcm⁻³, which is soluble in water, the pH of the 1% strength solution at 25° being 10.4.

Condensation of NaH₂PO₄ or of KH₂PO₄ gives rise to higher molecular weight sodium and potassium phosphates, among which it is possible to distinguish cyclic representatives, the sodium and potassium metaphosphates, and catonated types, the sodium and potassium polyphosphates. For the latter in particular a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6H₂O and has the general formula NaO—[P(O) (ONa)—O]ₙ—Na where n=3. About 17 g of the salt which is free from water of crystallization dissolve in 100 g of water at room temperature, at 60° about 20 g, at 100° around 32 g; after heating the solution at 100° for two hours, about 8% orthophosphate and 15% diphospate are produced by hydrolysis. For the preparation of pentasodium triphosphate, phosphoric acid is reacted with sodium carbonate solution or sodium hydroxide solution in stoichiometric ratio and water is removed from the solution by spraying. In a similar way to Graham's salt and sodium diphosphate, pentasodium triphosphate dissolves numerous insoluble metal compounds (including lime soaps etc.). Pentapotassium triphosphate, K₅P₃O₁₀ (potassium tripolyphosphate), is available commercially, for example, in the form of a 50% strength by weight solution (>23% P₂O₅, 25% K₂O). The potassium polyphosphates are used widely in the washing and cleaning product industry. There also exist sodium potassium tripolyphosphates which can likewise be used for the purposes of the present invention. These are formed, for example, when sodium trimetaphosphate is hydrolyzed with KOH:

(NaPO₃)₃+2KOH→Na₃K₂P₃O₁₀+H₂O

These can be used in accordance with the invention in precisely the same way as sodium tripolyphosphate, potassium tripolyphosphate or mixtures thereof; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

Suitable crystalline, layered sodium silicates have the general formula NaMSiₓO₂ₓ₊₁·H₂O, where M is sodium or hydrogen, x is a number from 1.9 to 4, y is a number from 0 to 20, and preferred values for x are 2, 3 or 4. Preferred crystalline sheet silicates of the given formula are those in which M is sodium and x assumes the values 2 or 3. In particular, both β- and also δ-sodium disilicates Na₂Si₂O₅·yH₂O are preferred.

It is also possible to use amorphous sodium silicates having an Na₂O:SiO₂ modulus of from 1:2 to 1:3.3, preferably from 1:2 to 1:2.8 and in particular from 1:2 to 1:2.6, which are dissolution-delayed and have secondary washing properties. The dissolution delay relative to conventional amorphous sodium silicates may have been brought about in a variety of ways, for example by surface treatment, compounding, compacting or by overdrying. For the purposes of this invention the term “amorphous” is understood as including “X-ray-amorphous”. This means that, in X-ray diffraction experiments, the silicates do not yield the sharp X-ray reflections typical of crystalline substances but instead yield at best one or more maxima of the scattered X-radiation, having a width of several degree units of the diffraction angle. However, even particularly good builder properties may result if the silicate particles in electron diffraction experiments yield vague or even sharp diffraction maxima. This is to be interpreted such that the products have microcrystalline regions with a size of from 10 to several hundred nm, values up to a maximum of 50 nm and in particular up to a maximum of 20 nm being preferred. Such so-called X-ray amorphous silicates likewise have delayed dissolution compared with conventional waterglasses. Particular preference is given to compacted amorphous silicates, compounded amorphous silicates and overdried X-ray amorphous silicates.

The finely crystalline synthetic zeolite used, containing bound water, is preferably zeolite A and/or P. Zeolite P is particularly preferably Zeolite MAP® (commercial product from Crosfield). Also suitable, however, are zeolite X, and mixtures of A, X and/or P. A co-crystallizate of zeolite X and zeolite A (about 80% by weight of zeolite X), which is sold by CONDEA Augusta S.p.A. under the trade name VEGOBOND AX® and can be described by the formula

nNa₂O·(1−n)K₂O·Al₂O₃·(2−2.5)SiO₂·(3.5−5.5)H₂O

is, for example, also commercially available and preferred for the purposes of the present invention. The zeolite can be used as a spray-dried powder or else as an undried stabilized suspension still moist from its preparation. If the zeolite is used as suspension, this suspension may comprise small additions of nonionic surfactants as stabilizers, for example 1 to 3% by weight, based on zeolite, of ethoxylated C₁₂-C₁₈-fatty alcohols having 2 to 5 ethylene oxide groups, C₁₂-C₁₄-fatty alcohols having 4 to 5 ethylene oxide groups or ethoxylated isotridecanols. Suitable zeolites have an average particle size of less than 10 μm (volume distribution; measurement method: Coulter Counter) and preferably contain 18 to 22% by weight, in particular 20 to 22% by weight, of bound water.

Further important builders are, in particular, the carbonates, citrates and silicates. Preference is given to using trisodium citrate and/or pentasodium tripolyphosphate and/or sodium carbonate and/or sodium bicarbonate and/or gluconates and/or silicatic builders from the class of disilicates and/or metasilicates.

Further constituents which may be present are alkali metal carriers. Suitable alkali metal carriers are alkali metal hydroxides, alkali metal carbonates, alkali metal hydrogencarbonates, alkali metal sesquicarbonates, alkali metal silicates, alkali metal metasilicates, and mixtures of said substances, preference being given for the purposes of this invention to the alkali metal carbonates, in particular sodium carbonate, sodium hydrogencarbonate or sodium sesquicarbonate.

Particular preference is given to a builder system comprising a mixture of tripolyphosphate and sodium carbonate.

A builder system comprising a mixture of tripolyphosphate and sodium carbonate and sodium disilicate is likewise particularly preferred.

In addition, further ingredients may be present, preference being given to washing, rinsing or cleaning products according to the invention which additionally comprise one or more substances from the group of acidifying agents, chelate complexing agents or of film-inhibiting polymers.

Possible acidifiers are either inorganic acids or organic acids provided these are compatible with the other ingredients. For reasons of consumer protection and handling safety, the solid mono-, oligo- and polycarboxylic acids in particular can be used. From this group, preference is in turn given to citric acid, tartaric acid, succinic acid, malonic acid, adipic acid, maleic acid, fumaric acid, oxalic acid, and polyacrylic acid. The anhydrides of these acids can also be used as acidifiers, maleic anhydride and succinic anhydride in particular being commercially available. Organic sulfonic acids, such as amidosulfonic acid can likewise be used. A composition which is commercially available and which can likewise preferably be used as acidifier for the purposes of the present invention is Sokalan® DCS (trademark of BASF), a mixture of succinic acid (max. 31% by weight), glutaric acid (max. 50% by weight) and adipic acid (max. 33% by weight).

A further possible group of ingredients are the chelate complexing agents. Chelate complexing agents are substances which form cyclic compounds with metal ions, where a single ligand occupies more than one coordination site on a central atom, i.e. is at least “bidentate”. In this case, stretched compounds are thus normally closed by complex formation via an ion to give rings. The number of bonded ligands depends on the coordination number of the central ion.

Chelate complexing agents which are customary and preferred for the purposes of the present invention are, for example, polyoxycarboxylic acids, polyamines, ethylenediaminetetraacetic acid (EDTA) and nitrilotriacetic acid (NTA). Complex-forming polymers, i.e. polymers which carry functional groups either in the main chain itself or laterally relative to this, which can act as ligands and react with suitable metal atoms usually to form chelate complexes, can also be used according to the invention. The polymer-bonded ligands of the resulting metal complexes can originate from just one macromolecule or else belong to different polymer chains. The latter leads to crosslinking of the material, provided the complex-forming polymers have not already been crosslinked beforehand via covalent bonds.

Complexing groups (ligands) of customary complex-forming polymers are iminodiacetic acid, hydroxyquinoline, thiourea, guanidine, dithiocarbamate, hydroxamic acid, amidoxime, aminophosphoric acid, (cycl.) polyamino, mercapto, 1,3-dicarbonyl and crown ether radicals, some of which have very specific activities toward ions of different metals. Basis polymers of many complex-forming polymers, which are also commercially important, are polystyrene, polyacrylates, polyacrylonitriles, polyvinyl alcohols, polyvinylpyridines and polyethylenimines. Natural polymers, such as cellulose, starch or chitin are also complex-forming polymers. Moreover, these may be provided with further ligand functionalities as a result of polymer-analogous modifications.

For the purposes of the present invention, particular preference is given to washing, rinsing or cleaning products which comprise one or more chelate complexing agents from the groups of

(i) polycarboxylic acids in which the sum of the carboxyl and optionally hydroxyl groups is at least 5,

(ii) nitrogen-containing mono- or polycarboxylic acids,

(iii) geminal diphosphonic acids,

(iv) aminophosphonic acids,

(v) phosphonopolycarboxylic acids,

(vi) cyclodextrins

in amounts above 0.1% by weight, preferably above 0.5% by weight, particularly preferably above 1% by weight and in particular above 2.5% by weight, in each case based on the weight of the dishwasher composition.

For the purposes of the present invention, it is possible to use all complexing agents of the prior art. These may belong to different chemical groups. Preference is given to using the following, individually or in a mixture with one another:

a) polycarboxylic acids in which the sum of the carboxyl and optionally hydroxyl groups is at least 5, such as gluconic acid,

b) nitrogen-containing mono- or polycarboxylic acids, such as ethylenediaminetetraacetic acid (EDTA), N-hydroxyethylethylenediaminetriacetic acid, diethylenetriaminepentaacetic acid, hydroxy-ethyliminodiacetic acid, nitridodiacetic acid-3-propionic acid, isoserinediacetic acid, N,N-di(β-hydroxyethyl)glycine, N-(1,2-dicarboxy-2-hydroxy-ethyl)glycine, N-(1,2-dicarboxy-2-hydroxyethyl)-aspartic acid or nitrilotriacetic acid (NTA),

c) geminal diphosphonic acids, such as 1-hydroxyethane-1,1-diphosphonic acid (HEDP), higher homologs thereof having up to 8 carbon atoms, and hydroxy or amino group-containing derivatives thereof and 1-aminoethane-1,1-diphosphonic acid, higher homologs thereof having up to 8 carbon atoms, and hydroxy or amino group-containing derivatives thereof,

d) aminophosphonic acids, such as ethylenediamine-tetra(methylenephosphonic acid), diethylenetri-aminepenta(methylenephosphonic acid) or nitrilotri-(methylenephosphonic acid),

e) phosphonopolycarboxylic acids, such as 2-phosphono-butane-1,2,4-tricarboxylic acid, and

f) cyclodextrins.

For the purposes of this patent application, polycarboxylic acids a) are understood as meaning carboxylic acids—including monocarboxylic acids—in which the sum of carboxyl and the hydroxyl groups present in the molecule is at least 5. Complexing agents from the group of nitrogen-containing polycarboxylic acids, in particular EDTA, are preferred. At the alkaline pH values of the treatment solutions required according to the invention, these complexing agents are at least partially in the form of anions. It is unimportant whether they are introduced in the form of acids or in the form of salts. In the case of using salts, alkali metal, ammonium or alkylammonium salts, in particular sodium salts, are preferred.

Film-inhibiting polymers may likewise be present in the compositions according to the invention. These substances, which may have chemically different structures, originate, for example, from the groups of low molecular weight polyacrylates with molar masses between 1000 and 20 000 daltons, preference being given to polymers with molar masses below 15 000 daltons.

Film-inhibiting polymers may also have cobuilder properties. Organic cobuilders which may be used in the dishwasher detergents according to the invention are, in particular, polycarboxylates/polycarboxylic acids, polymeric polycarboxylates, aspartic acid, polyacetals, dextrins, further organic cobuilders (see below) and phosphonates. These classes of substance are described below.

Organic builder substances which can be used are, for example, the polycarboxylic acids usable in the form of their sodium salts, the term polycarboxylic acids meaning carboxylic acids which carry more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), provided such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

The acids per se may also be used. In addition to their builder action, the acids typically also have the property of an acidifying component and thus also serve to establish a lower and milder pH of detergents or cleaners. In this connection, particular mention is made of citric acid, succinic acid, glutaric acid, adipic acid, gluconic acid and any mixtures thereof.

Also suitable as builders or film inhibitors are polymeric polycarboxylates; these are, for example, the alkali metal salts of polyacrylic acid or of polymethacrylic acid, for example those having a relative molecular mass of from 500 to 70 000 g/mol.

The molar masses given for polymeric polycarboxylates are, for the purposes of this specification, weight-average molar masses M_{W} of the respective acid form, determined fundamentally by means of gel permeation chromatography (GPC) using a UV detector, The measurement was made against an external polyacrylic acid standard which, owing to its structural similarity to the polymers under investigation, provides realistic molecular weight values. These figures differ considerably from the molecular weight values obtained using polystyrenesulfonic acids as the standard. The molar masses measured against polystyrenesulfonic acids are usually considerably higher than the molar masses given in this specification.

Suitable polymers are in particular polyacrylates which preferably have a molecular mass of from 500 to 20 000 g/mol. Owing to their superior solubility, preference in this group may be given in turn to the short-chain polyacrylates which have molar masses of from 1000 to 10 000 g/mol and particularly preferably from 1000 to 4000 g/mol.

In the products according to the invention, particular preference is given to using both polyacrylates and also copolymers of unsaturated carboxylic acids, monomers containing sulfonic acid groups, and optionally further ionic or nonionogenic monomers. The copolymers containing sulfonic acid groups are described in detail below.

Also suitable are copolymeric polycarboxylates, in particular those of acrylic acid with methacrylic acid and of acrylic acid or methacrylic acid with maleic acid. Copolymers which have proven to be particularly suitable are those of acrylic acid with maleic acid which contain from 50 to 90% by weight of acrylic acid and 50 to 10% by weight of maleic acid. Their relative molecular mass, based on free acids, is generally 2000 to 70 000 g/mol, preferably 20 000 to 50 000 g/mol and in particular 30 000 to 40 000 g/mol.

The (co)polymeric polycarboxylates can either be used as powders or as aqueous solutions. The (co)polymeric polycarboxylate content of the agents is preferably 0.5 to 20% by weight, in particular 3 to 10% by weight.

Particular preference is also given to biodegradable polymers of more than two different monomer units, for example those which contain, as monomers, salts of acrylic acid or of maleic acid, and vinyl alcohol or vinyl alcohol derivatives, or those which contain, as monomers, salts of acrylic acid and of 2-alkylallyl-sulfonic acid, and sugar derivatives. Further preferred copolymers are those which preferably have, as monomers, acrolein and acrylic acid/acrylic acid salts or acrolein and vinyl acetate.

Further preferred builder substances which are likewise to be mentioned are polymeric aminodicarboxylic acids, salts thereof or precursor substances thereof. Particular preference is given to polyaspartic acids or salts and derivatives thereof, which also have a bleach-stabilizing effect as well as cobuilder properties.

Further suitable builder substances are polyacetals which can be obtained by reacting dialdehydes with polyolcarboxylic acids which have 5 to 7 carbon atoms and at least 3 hydroxyl groups. Preferred polyacetals are obtained from dialdehydes, such as glyoxal, glutaraldehyde, terephthalaldehyde, and mixtures thereof and from polyolcarboxylic acids, such as gluconic acid and/or glucoheptonic acid.

Further suitable organic builder substances are dextrins, for example oligomers or polymers of carbohydrates, which can be obtained by partial hydrolysis of starches. The hydrolysis can be carried out in accordance with customary processes, for example acid-catalyzed or enzyme-catalyzed processes. The hydrolysis products preferably have average molar masses in the range from 400 to 500 000 g/mol. Preference is given here to a polysaccharide with a dextrose equivalent (DE) in the range from 0.5 to 40, in particular from 2 to 30, where DE is a common measure of the reducing effect of a polysaccharide compared with dextrose, which has a DE of 100. It is also possible to use maltodextrins with a DE between 3 and 20 and dried glucose syrups with a DE between 20 and 37, and also so-called yellow dextrins and white dextrins with relatively high molar masses in the range from 2000 to 30 000 g/mol.

The oxidized derivatives of such dextrins are their reaction products with oxidizing agents which are able to oxidize at least one alcohol function of the saccharide ring to the carboxylic acid function. A product oxidized on the C₆ of the saccharide ring may be particularly advantageous.

Oxydisuccinates and other derivatives of disuccinates, preferably ethylenediaminedisuccinate, are also further suitable cobuilders. Here, ethylenediamine N,N′-disuccinate (EDDS) is preferably used in the form of its sodium or magnesium salts. In this connection, preference is also given to glycerol disuccinates and glycerol trisuccinates. Suitable use amounts in zeolite-containing and/or silicate-containing formulations are 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and at most two acid groups.

A further class of substances with cobuilder properties is the phosphonates. These are, in particular, hydroxyalkane- and aminoalkanephosphonates. Among the hydroxyalkanephosphonates, 1-hydroxyethane-1,1-diphosphonate (HEDP) is of particular importance as cobuilder. It is preferably used as the sodium salt, the disodium salt giving a neutral reaction and the tetrasodium salt giving an alkaline reaction (pH 9). Suitable aminoalkanephosphonates are preferably ethylenediaminetetramethylenephosphonate (EDTMP), diethylenetriaminepentamethylenephosphonate (DTPMP) and higher homologs thereof. They are preferably used in the form of the neutrally reacting sodium salts, e.g. as the hexasodium salt of EDTMP or as the hepta- and octasodium salt of DTPMP. Here, preference is given to using HEDP as builder from the class of phosphonates. In addition, the aminoalkanephosphonates have a marked heavy metal-binding capacity. Accordingly, particularly if the compositions also comprise bleaches, it may be preferable to use aminoalkanephosphonates, in particular DTPMP, or mixtures of said phosphonates.

In addition to the substances from said classes of substances, the products according to the invention can comprise further customary ingredients of washing, rinsing or cleaning products, where bleaches, bleach activators, enzymes, silver protectants, dyes and fragrances are of particular importance. These substances are described below.

Among the compounds which serve as bleaches and liberate H₂O₂ in water, sodium perborate tetrahydrate and sodium perborate monohydrate are of particular importance. Examples of further bleaches which may be used are sodium percarbonate, peroxypyrophosphates, citrate perhydrates and H₂O₂-supplying peracidic salts or peracids, such as perbenzoates, peroxophthalates, diperazelaic acid, phthaloimino peracid or diperdodecanedioic acid.

In order to achieve an improved bleaching effect during washing at temperatures of 60° C. and below, bleach activators can be incorporated into the washing and cleaning product moldings. Bleach activators which can be used are compounds which, under perhydrolysis conditions, produce aliphatic peroxocarboxylic acids having preferably 1 to 10 carbon atoms, in particular 2 to 4 carbon atoms, and/or optionally substituted perbenzoic acid. Substances which carry O-acyl and/or N-acyl groups of said number of carbon atoms and/or optionally substituted benzoyl groups are suitable. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran.

In addition to the conventional bleach activators, or instead of them, so-called bleach catalysts may also be incorporated into the moldings. These substances are bleach-boosting transition metal salts or transition metal complexes, such as, for example, Mn-, Fe-, Co-, Ru- or Mo-salen complexes or -carbonyl complexes. Mn, Fe, Co, Ru, Mo, Ti, V and Cu complexes with N-containing tripod ligands, and Co-, Fe-, Cu- and Ru-ammine complexes can also be used as bleach catalysts.

Suitable enzymes are, in particular, those from the classes of hydrolases, such as the proteases, esterases, lipases or lipolytic enzymes, amylases, cellulases or other glycosylhydrolases and mixtures of said enzymes. In the washing, all of these hydrolases contribute to the removal of protein-containing, grease-containing or starch-containing stains and graying. Cellulases and other glycosylhydrolases may, furthermore, contribute, by removing pilling and microfibrils, to color retention and to an increase in the softness of the textile. For bleaching and/or for inhibiting color transfer it is also possible to use oxyreductases. Especially suitable enzymatic active ingredients are those obtained from bacterial strains or fungi such as Bacillus subtilis, Bacillus licheniformis, Streptomyceus griseus and Humicola insolens. Preference is given to using proteases of the subtilisin type, and especially to proteases obtained from Bacillus lentus. Of particular interest in this connection are enzyme mixtures, for example of protease and amylase or protease and lipase or lipolytic enzymes or protease and cellulase or of cellulase and lipase or lipolytic enzymes or of protease, amylase and lipase or lipolytic enzymes or protease, lipase or lipolytic enzymes and cellulase, but in particular protease and/or lipase-containing mixtures or mixtures containing lipolytic enzymes. Examples of such lipolytic enzymes are the known cutinases. Peroxidases or oxidases have also proven suitable in some cases. The suitable amylases include, in particular, α-amylases, isoamylases, pullulanases, and pectinases. The cellulases used are preferably cellobiohydrolases, endoglucanases and β-glucosidases, which are also called cellobiases, or mixtures thereof. Because different types of cellulase differ in their CMCase and avicelase activities, specific mixtures of the cellulases may be used to establish the desired activities.

The enzymes can be adsorbed in carrier substances or be embedded in coating substances in order to protect them against premature decomposition. The content of enzymes, enzyme mixtures or enzyme granulates may, for example, be from about 0.1 to 5% by weight, preferably 0.12 to about 2% by weight.

The cleaning products according to the invention for machine dishwashing may comprise corrosion inhibitors in order to protect the ware or the machine, particular importance in the field of machine dishwashing being attached to silver protectants. The known substances of the prior art may be used. In general, silver protectants may be chosen particularly from the group of triazoles, benzotriazoles, bisbenzotriazoles, aminotriazoles, alkylaminotriazoles and the transition metal salts or complexes. Particular preference is given to the use of benzotriazole and/or alkylaminotriazole. Frequently encountered in cleaning formulations, moreover, are agents containing active chlorine, which can significantly reduce the corrosion of the silver surface. In chlorine-free cleaners, use is made in particular of oxygen-containing and nitrogen-containing organic redox-active compounds, such as divalent and trivalent phenols, e.g. hydroquinone, pyrocatechol, hydroxyhydroquinone, gallic acid, phloroglucinol, pyrogallol and derivatives of these classes of compounds. Salt-like and complex inorganic compounds, such as salts of the metals Mn, Ti, Zr, Hf, V, Co and Ce also find frequent application. Preference is given here to the transition metal salts chosen from the group of manganese and/or cobalt salts and/or complexes, particularly preferably cobalt(ammine) complexes, cobalt(acetato) complexes, cobalt(carbonyl) complexes, the chlorides of cobalt or of manganese and manganese sulfate. Zinc compounds can likewise be used to prevent corrosion on the ware.

A broad number of highly diverse salts can be used as electrolytes from the group of inorganic salts. Preferred cations are the alkali metal and alkaline earth metals, preferred anions being the halides and sulfates. From a preparation point of view, the use of NaCl or MgCl₂ in the products according to the invention is preferred. The content of electrolytes in the products according to the invention is usually 0.5 to 5% by weight.

Nonaqueous solvents which can be used in the products according to the invention originate, for example, from the group of mono- or polyhydric alcohols, alkanolamines or glycol ethers, provided they are miscible with water in the stated concentration range. The solvents are preferably chosen from ethanol, n- or isopropanol, butanols, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or -ethyl ether, diisopropylene glycol monomethyl or -monoethyl ether, methoxy, ethoxy or butoxy triglycol, 1-butoxyethoxy-2-propanol, 3-methyl-3-methoxybutanol, propylene-glycol-t-butyl ether, and mixtures of these solvents. Nonaqueous solvents can be used in the liquid detergents according to the invention in amounts between 0.5 and 10% by weight, but preferably less than 5% by weight and in particular less than 3% by weight.

In order to bring the pH of the products according to the invention into the desired range, it is possible to use pH regulators. Use can be made here of any known acids or alkalis, provided their use is not precluded for application or ecological reasons or for reasons of consumer protection. The amount of these regulators does not usually exceed 5% by weight of the total formulation.

In order to improve the esthetic impression of the products according to the invention, they can be colored with suitable dyes. Preferred dyes, the choice of which does not present any problems at all to the person skilled in the art, have high storage stability and high insensitivity toward the other ingredients of the products and toward light, and do not have marked substantivity toward textile fibers so as not to color these.

Suitable foam inhibitors which can be used in the products according to the invention are, for example, soaps, paraffins or silicone oils, which may optionally be applied to carrier materials. Suitable anti-redeposition agents, which are also referred to as soil repellents, are, for example, nonionic cellulose ethers, such as methylcellulose and methylhydroxypropylcellulose with a content of methoxy groups of from 15 to 30% by weight and of hydroxypropyl groups of from 1 to 15% by weight, in each case based on the nonionic cellulose ethers, and the polymers, known from the prior art, of phthalic acid and/or terephthalic acid or derivatives thereof, in particular polymers of ethylene terephthalates and/or polyethylene glycol terephthalates or anionically and/or nonionically modified derivatives of these. Of these, particular preference is given to the sulfonated derivatives of phthalic acid and terephthalic acid polymers.

Optical brighteners (so-called “whitening agents”) can be added to the products according to the invention in order to eliminate graying and yellowing of the treated textiles. These substances attach to the fibers and bring about a brightening and simulated bleaching action by converting invisible ultraviolet radiation into visible longer-wave length light, the ultraviolet light absorbed from sunlight being irradiated as a pale bluish fluorescence and, together with the yellow shade of the grayed or yellowed laundry, producing pure white. Suitable compounds originate, for example, from the classes of substance of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthal-imides, benzoxazol, benzisoxazol and benzimidazol systems, and pyrene derivatives substituted by heterocycles. The optical brighteners are usually used in amounts between 0.05 and 0.3% by weight, based on the finished product.

Graying inhibitors have the task of holding the soiling detached from the fiber in suspended form in the liquor, thus preventing the soiling from reattaching. Suitable for this purpose are water-soluble colloids, mostly of an organic nature, for example glue, gelatin, salts of ether sulfonic acids of starch or of cellulose or salts of acidic sulfuric esters of cellulose or of starch. Water-soluble polyamides which contain acidic groups are also suitable for this purpose. In addition, it is possible to use soluble starch preparations, and starch products other than those mentioned above, e.g. degraded starch, aldehyde starches etc. It is also possible to use polyvinylpyrrolidone. Preference is, however, given to using cellulose ethers, such as carboxymethylcellulose (Na salt), methylcellulose, hydroxyalkylcellulose and mixed ethers, such as methylhydroxyethylcellulose, methylhydroxypropylcellulose, methylcarboxymethylcellulose and mixtures thereof in amounts of from 0.1 to 5% by weight, based on the products.

If the products according to the invention are formulated as products for machine dishwashing, then further ingredients may be used. Dishes which have been washed by machine are nowadays often subject to higher requirements than dishes washed manually. For example, even dishes which have been completely cleaned of food residue will not be evaluated as being perfect if, after machine dishwashing, they still have whitish marks based on water hardness or other mineral salts which, due to a lack of wetting agents, originate from dried-on water drops. In order to obtain sparkling and stain-free dishes, a rinse aid is therefore used nowadays with success. The addition of rinse aid at the end of the wash program ensures that the water runs off from the ware as completely as possible, so that the various surfaces at the end of the wash program are residue-free and flawlessly sparkling. Machine dishwashing in domestic dishwashers usually involves a prewash cycle, a main wash cycle and a clear-rinse cycle, which are interrupted by intermediate rinse cycles. With most machines, the prewash cycle for heavily soiled dishes can be selected, but is only chosen by the consumer in exceptional cases, meaning that in most machines a main wash cycle, an intermediate rinse cycle with clean water and a clear-rinse cycle are carried out. The temperature of the main wash cycle varies between 40 and 65° C. depending on the machine model and program selected. In the clear-rinse cycle, rinse aids, which usually comprise nonionic surfactants as the main constituent, are added from a dosing chamber in the machine. Such rinse aids are in liquid form and are described widely in the prior art. Their task consists primarily in preventing lime marks and films on the dishes.

The products according to the invention can be formulated as “normal” cleaners, which are used together with standard commercial supplementing agents (rinse aids, regenerating salt). However, using the products according to the invention, it is a particular advantage that the additional dosing of rinse aids can be dispensed with. These so-called “2-in-1” products lead to easier handling and take away from the consumer the burden of additionally dosing two different products (detergent and rinse aid).

Even when using “2-in-1” products, two dosing operations are required at intervals for operating a domestic dishwasher since the regenerating salt has to be topped up in the water softening system of the machine after a certain number of wash cycles. These water-softening systems consist of ion exchanger polymers which soften the hard water entering the machine and, after the wash program, are regenerated as a result of rinsing with salt water.

However, it is also possible to provide products according to the invention which, being so-called “3 in 1” products, combine the conventional detergent, rinse aid and a salt replacement function. In this regard preference is given to dishwasher detergents according to the invention which additionally comprise 0.1 to 70% by weight of copolymers of

i) unsaturated carboxylic acids,

ii) monomers containing sulfonic acid groups

iii) optionally further ionic or nonionogenic monomers.

These copolymers lead to the parts of dishes treated with such compositions becoming significantly cleaner in subsequent washing operations than parts of dishes which were rinsed with conventional compositions.

An additional positive effect is the shortening of the drying time of the parts of dishes treated with the detergent, i.e. the consumer can take the dishes from the machine earlier and reuse them after the wash program is finished.

The invention is notable for improved “cleanability” of the treated substrates during later washing operations and for a considerable shortening of the drying time compared with comparable products without the use of polymers containing sulfonic acid groups.

For the purposes of the teaching according to the invention, drying time is generally understood as having the literal meaning, i.e. the time which elapses until a surface of the dishes treated in a dishwasher machine has dried, but in particular which elapses until 90% of a surface treated with a cleaning composition or rinse aid in concentrated or diluted form has dried.

For the purposes of the present invention, unsaturated carboxylic acids of the formula VI are preferred as monomer,

R¹(R²)C═C(R³)COOH (VI),

in which R¹ to R³, independently of one another, are —H, CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms.

Among the unsaturated carboxylic acids which can be described by the formula VI, particular preference is given to acrylic acid (R¹═R²═R³═H), methacrylic acid (R¹═R²═H; R³═CH₃) and/or maleic acid (R¹═COOH; R²═R³═H).

In the case of the monomers containing sulfonic acid groups, preference is given to those of the formula VI¹,

R⁵(R⁶)C═C(R⁷)—X—SO₃H (VII),

in which R⁵ to R⁷, independently of one another, are —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms, and X is an optionally present spacer group which is chosen from —(CH₂) n-, where n=0 to 4, —COO—(CH₂)ₖ— where k=1 to 6, —C(O)—NH—C(CH₃)₂— and —C(O)—NH—CH(CH₂CH₃)—.

Among these monomers, preference is given to those of the formulae VIIa, VIIb and/or VIIc,

H₂C═CH—X—SO₃H (VIIa),

H₂C═C(CH₃)—X—SO₃H (VIIb),

HO₃S—X—(R⁶)C═C(R⁷)—X—SO₃H (VIIc),

in which R⁶ and R⁷, independently of one another, are chosen from —H, —CH₃, —CH₂CH₃, —CH₂CH₂CH₃, —CH(CH₃)₂ and X is an optionally present spacer group which is chosen from —(CH₂)ₙ—, where n=0 to 4, —COO—(CH₂)ₖ— where k=1 to 6, —C(O)—NH—C(CH₃) 2— and —C(O)—NH—CH(CH₂CH₃)—.

Particularly preferred monomers containing sulfonic acid groups here are 1-acrylamido-1-propanesulfonic acid (X=—C(O)NH—CH(CH₂CH₃) in formula VIIa), 2-acrylamido-2-propanesulfonic acid (X=—C(O)NH—C(CH₃)₂ in formula VIIa), 2-acrylamido-2-methyl-1-propanesulfonic acid (X≡C(O)NH—CH(CH₃)CH₂— in formula VIIa), 2-methacrylamido-2-methyl-1-propanesulfonic acid (X=—C(O)NH—CH(CH₃)CH₂— in formula VIIb), 3-methacrylamido-2-hydroxypropanesulfonic acid (X=C(O)NH—CH₂CH(OH)CH₂— in formula VIIb), allylsulfonic acid (X=CH₂ in formula VIIa), methallylsulfonic acid (X=CH₂ in formula VIIb), allyloxybenzenesulfonic acid (X=CH₂—O—C₆H₄— in formula XVIIa), methallyloxybenzenesulfonic acid (X=CH₂—O—C₆H₄—in formula VIIb), 2-hydroxy-3-(2-propenyl-oxy)propanesulfonic acid, 2-methyl-2-propene-1-sulfonic acid (X=CH₂ in formula VIIb), styrenesulfonic acid (X=C₆H₄ in formula VIIa), vinylsulfonic acid (X not present in formula VIIa), 3-sulfopropyl acrylate (X≡C(O)NH—CH₂CH₂CH₂— in formula VIIa), 3-sulfopropyl methacrylate (X=—C(O)NH—CH₂CH₂CH₂— in formula VIIb), sulfomethacrylamide (X=C(O)NH— in formula VIIb), sulfomethyl methacrylamide (X=C(O)NH—CH₂— in formula VIIb) and water-soluble salts of said acids.

Suitable further ionic or nonionogenic monomers are, in particular, ethylenically unsaturated compounds. Preferably the content of the monomers of group iii) in the polymers used according to the invention is less than 20% by weight, based on the polymer. Polymers to be used with particular preference consist merely of monomers of groups i) and ii).

In summary, copolymers of

i) unsaturated carboxylic acids of the formula VI

R¹(R²)C═C(R³)COOH (VI),

in which R¹ to R³, independently of one another, are —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms,

ii) monomers of the formula VII containing sulfonic acid groups

R⁵ (R⁶)C═C(R⁷)—X—SO₃H (VII),

in which R⁵ to R⁷, independently of one another, are —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above and substituted by —NH₂, —OH or —COOH, or —COOH or —COOR⁴, where R⁴ is a saturated or unsaturated, straight-chain or branched hydrocarbon radical having 1 to 12 carbon atoms, and X is an optionally present spacer group which is chosen from —(CH₂)ₙ—, where n=0 to 4, —COO—(CH₂)ₖ— where k=1 to 6, —C(O)—NH—C(CH₃)₂— and —C(O)—NH—CH(CH₂CH₃)—

iii) optionally further ionic or nonionogenic monomers are particularly preferred.

Particularly preferred copolymers consist of

i) one or more unsaturated carboxylic acids from the group consisting of acrylic acid, methacrylic acid and/or maleic acid

ii) one or more monomers containing sulfonic acid groups and of the formulae VIIa, VIIb and/or VIIc:

H₂C═CH—X—SO₃H (VIIa),

H₂C═C(CH₃)—X—SO₃H (VIIb),

HO₃S—X— (R⁶)C═C(R⁷)—X—SO₃H (VIIc),

in which R⁶ and R⁷, independently of one another, are chosen from —H, —CH₃, —CH₂CH₃, —CH₂CH₂CH₃, —CH(CH₃)₂ and X is an optionally present spacer group which is chosen from —(CH₂)—, where n=0 to 4, —COO—(CH₂)ₖ—, where k=1 to 6, —C(O)—NH—C(CH₃)₂— and —C(O)—NH—CH(CH₂CH₃)—

iii) optionally further ionic or nonionogenic monomers.

The copolymers present according to the invention in the products can comprise the monomers from groups i) and ii), and optionally iii) in varying amounts, where all of the representatives from group i) can be combined with all of the representatives from group ii) and all of the representatives from group iii). Particularly preferred polymers have certain structural units which are described below.

Thus, for example, preference is given to products according to the invention which are characterized in that they comprise one or more copolymers which contain structural units of the formula VIII

—[CH₂—CHCOOH]ₘ—[CH₂—CHC(O)—Y—SO₃H]ₚ— (VIII),

in which m and p are in each case a whole natural number between 1 and 2000, and Y is a spacer group chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

These polymers are prepared by copolymerization of acrylic acid with an acrylic acid derivative containing sulfonic acid groups. Copolymerizing the acrylic acid derivative containing sulfonic acid groups with methacrylic acid leads to another polymer which is likewise used with preference in the products according to the invention and is characterized in that the products comprise one or more copolymers which contain structural units of the formula IX

—[CH₂—C(CH₃)COOH]ₘ—[CH₂—CHC(O)—Y—SO₃H]ₚ— (IX),

in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

Entirely analogously, acrylic acid and/or methacrylic acid can also be copolymerized with methacrylic acid derivatives containing sulfonic acid groups, as a result of which the structural units in the molecule are changed. For example, products according to the invention which comprise one or more copolymers which contain structural units of the formula X

—[CH₂—CHCOOH]ₘ—[CH₂—C(CH₃)C(O)—Y—SO₃H]ₚ— (X),

in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred, are likewise a preferred embodiment of the present invention, just as preference is also given to products which are characterized in that they comprise one or more copolymers which contain structural units of the formula XI

—[CH₂—C(CH₃)COOH]ₘ—[CH₂—C(CH₃)C(O)—Y—SO₃H]ₚ— (XI),

in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

In place of acrylic acid and/or methacrylic acid, or in addition thereto, it is also possible to use maleic acid as particularly preferred monomer from group i). This gives products preferred according to the invention which are characterized in that they comprise one or more copolymers which contain structural units of the formula XI

—[HOOCCH—CHCOOH]ₘ—[CH₂—CHC(O)—Y—SO₃H]ₚ— (XI),

in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred, and gives products which are characterized in that they comprise one or more copolymers which contain structural units of the formula XII

—[HOOCCH—CHCOOH]ₘ—[CH₂—C(CH₃)C(O)O—Y—SO₃H]ₚ— (XII),

in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

In summary, dishwasher detergents according to the invention are preferred which comprise, as ingredient b), one or more copolymers which contain structural units of the formulae VII and/or VIII and/or 1× and/or X and/or XI and/or XII

—[CH₂—CHCOOH]ₘ—[CH₂—CHC(O)—Y—SO₃H]ₚ— (VII),

—[CH₂C(CH₃)COOH]ₘ—[CH₂—CHC(O)—Y—SO₃H]ₚ— (VIII),

—[CH₂'CHCOOH]ₘ[CH₂—C(CH₃)C(O)—Y—SO₂H]ₚ— (IX),

—[CH₂—C(CH₃)COOH]ₘ—[CH₂—C(CH₃)C(O)—Y—SO₃H]ₚ— (X),

—[HOOCCH—CHCOOH]ₘ—[CH₂—CHC(O)—Y—SO₃H]ₚ— (XI),

—[HOOCCH—CHCOOH]ₘ[CH₂—C(CH₃)C(O)O—Y—SO₃H]ₚ— (XII),

in which m and p are in each case a whole natural number between 1 and 2000, and Y is a spacer group which is chosen from substituted or unsubstituted aliphatic, aromatic or araliphatic hydrocarbon radicals having 1 to 24 carbon atoms, where spacer groups in which Y is —O—(CH₂)ₙ—, where n=0 to 4, is —O—(C₆H₄)—, is —NH—C(CH₃)₂— or —NH—CH(CH₂CH₃)— are preferred.

In the polymers, all or some of the sulfonic acid groups can be present in neutralized form, i.e. the acidic hydrogen atom of the sulfonic acid group in some or all sulfonic acid groups can be replaced with metal ions, preferably alkali metal ions and in particular with sodium ions. Corresponding products which are characterized in that the sulfonic acid groups in the copolymer are in partially or completely neutralized form are preferred in accordance with the invention.

The monomer distribution of the copolymers used in the products according to the invention is, in the case of copolymers which comprise only monomers from groups i) and ii), preferably in each case 5 to 95% by weight of i) or ii), particularly preferably 50 to 90% by weight of monomer from group i) and 10 to 50% by weight of monomer from group ii), in each case based on the polymer.

In the case of terpolymers, particular preference is given to those which comprise 20 to 85% by weight of monomer from group i), 10 to 60% by weight of monomer from group ii), and 5 to 30% by weight of monomer from group iii).

The molar mass of the polymers used in the products according to the invention can be varied in order to match the properties of the polymers to the desired intended use. Preferred dishwasher detergents are characterized in that the copolymers have molar masses of from 2000 to 200 000 gmol⁻¹, preferably from 4000 to 25 000 gmol⁻¹ and in particular from 5000 to 15 000 gmol⁻¹.

The content of one or more copolymers in the products according to the invention can vary depending on the intended use and desired product performance, preferred dishwasher detergents according to the invention being characterized in that the copolymer or copolymers is/are present in amounts of from 0.25 to 50% by weight, preferably from 0.5 to 35% by weight, particularly preferably from 0.75 to 20% by weight and in particular from 1 to 15% by weight.

As already mentioned above, in the compositions according to the invention particular preference is given both to using polyacrylates and also the above-described copolymers of unsaturated carboxylic acids, monomers containing sulfonic acid groups, and optionally further ionic or nonionogenic monomers. The polyacrylates have been described in detail above. Particular preference is given to combinations of the above-described copolymers containing sulfonic acid groups with polyacrylates of low molar mass, for example in the range between 1000 and 4000 daltons. Such polyacrylates are commercially available under the trade name Sokalan® PA15 and Sokalan® PA25 (BASF).

The products according to the invention can also be formulated as fabric softeners or detergent additives. Depending on the desired intended use, further ingredients may be used. Softener compositions for rinse-cycle softening are described widely in the prior art. These compositions usually comprise, as active substance, a cationic quaternary ammonium compound which is dispersed in water. Depending on the content of active substance in the finished softener composition, the terms used are either dilute, ready-to-use products (active substance contents below 7% by weight) or so-called concentrates (active substance content above 7% by weight). Because of the smaller volume and the simultaneously reduced packaging and transportation costs, the textile softener concentrates have advantages from an ecological point of view and have penetrated the market to an increasing extent. Because of the incorporation of cationic compounds which have only low solubility in water, customary softener compositions are in the form of dispersions, have a milky-cloudy appearance and are not transparent. For reasons of product esthetics, it can, however, also be desirable to provide the consumer with transparent, clear softeners which are optically superior over the known products.

As textile-softening active substance, fabric softeners in portions according to the invention preferably comprise cationic surfactants, which have already been described above in detail (formulae XII, XIII and XIV). “Fabric softener portions” according to the invention particularly preferably comprise so-called ester quats. While there is a large number of possible compounds from this class of substance, according to the invention, particular preference is given to using ester quats which can be prepared by reacting trialkanolamines with a mixture of fatty acids and dicarboxylic acids, optional subsequent alkoxylation of the reaction product and quaternization in a manner known per se, as is described in DE 195 39 846.

The ester quats prepared in this way are suitable in an excellent manner for producing portions according to the invention which can be used as fabric softeners. Since, depending on the choice of trialkanolamine, fatty acids and dicarboxylic acids, and the quaternizing agent, a large number of suitable products can be prepared and used in the products according to the invention, a description of the ester quats to be used preferably according to the invention via their preparation route is more precise than giving a general formula.

Said components, which react with one another to give the ester quats to be used in preference, can be used in varying quantitative ratios relative to one another. For the purposes of the present invention, preference is given to fabric softeners in portions in which a reaction product of trialkanolamines with a mixture of fatty acids and dicarboxylic acids in the molar ratio 1:10 to 10:1, preferably 1:5 to 5:1, which has optionally been alkoxylated and then quaternized in a manner known per se, is present in amounts of from 2 to 60% by weight, preferably 3 to 35% by weight and in particular 5 to 30% by weight. Particular preference here is given to the use of triethanolamine, such that further preferred fabric softeners in portions of the present invention comprise a reaction product of triethanolamine with a mixture of fatty acids and dicarboxylic acids in the molar ratio 1:10 to 10:1, preferably 1:5 to 5:1, which has optionally been alkoxylated and then quaternized in a manner known per se, in amounts of from 2 to 60% by weight, preferably 3 to 35% by weight and in particular 5 to 30% by weight.

Fatty acids which can be used in the reaction mixture for preparing the ester quats are all acids obtained from vegetable or animal oils and fats. Here, it is entirely possible that the fatty acid used in the reaction mixture is a fatty acid which is not solid at room temperature, i.e. is pasty to liquid.

The fatty acids may, irrespective of their state of aggregation, be saturated or mono- to polyunsaturated. It is of course possible to use not only “pure” fatty acids, but also the technical-grade fatty acid mixtures obtained during the cleavage of fats and oils, these mixtures in turn being clearly preferred from an economical point of view.

For example, in the reaction mixtures for the preparation of the ester quats for the clear aqueous fabric softeners according to the invention, it is possible, for example, to use individual species or mixtures of the following acids: caprylic acid, pelargonic acid, capric acid, lauric acid, myristic acid, palmitic acid, stearic acid, octadecan-12-ol acid, arachidic acid, behenic acid, lignoceric acid, cerotic acid, melissic acid, 10-undecanoic acid, petroselic acid, petroselaidic acid, oleic acid, elaidic acid, ricinoleic acid, linolaidic acid, α- and β-eleosteric acid, gadoleic acid, erucic acid, brassidic acid. It is of course also possible to use the fatty acids with an uneven number of carbon atoms, for example undecanoic acid, tridecanoic acid, pentadecanoic acid, heptadecanoic acid, nonadecanoic acid, heneicosanoic acid, tricosanoic acid, pentacosanoic acid, heptacosanoic acid.

For the purposes of the present invention, the use of fatty acids of the formula XIII in the reaction mixture for the preparation of the ester quats is preferred, such that preferred fabric softeners in portions comprise a reaction product of trialkanolamines with a mixture of fatty acids of the formula XIII,

R¹—CO—OH (XIII)

in which R¹—CO— is an aliphatic, linear or branched acyl radical having 6 to 22 carbon atoms and 0 and/or 1, 2 or 3 double bonds, and dicarboxylic acids in the molar ratio 1:10 to 10:1, preferably 1:5 to 5:1, which has optionally been alkoxylated and then quaternized in a manner known per se, in amounts of from 2 to 60% by weight, preferably 3 to 35% by weight and in particular 5 to 30% by weight in the products.

Suitable dicarboxylic acids which are suitable for the preparation of the ester quats to be used in the products according to the invention are primarily saturated or mono- or polyunsaturated α-ω-dicarboxylic acids. By way of example, mention may be made here of the saturated species oxalic acid, malonic acid, succinic acid, glutaric acid, adipic acid, pimelic acid, suberic acid, azelaic acid, sebacic acid, undecanoic and dodecanoic acid, brassylic acid, tetra- and pentadecanoic acid, thapsic acid, and hepta-, octa- and nonadecanoic acid, eicosanoic and heneicosanoic acid, and phellogenic acid. In the reaction mixture, preference is given to using dicarboxylic acids which follow the general formula XXIII, so that products according to the invention in portions are preferred which comprise a reaction product of trialkanolamines with a mixture of fatty acids and dicarboxylic acids of the formula XIV,

HO—OC-[X]-CO—OH (XIV)

in which X is an optionally hydroxy-substituted alkylene group having 1 to 10 carbon atoms, in the molar ratio 1:10 to 10:1, preferably 1:5 to 5:1, which has optionally been alkoxylated and then quaternized in a manner known per se, in amounts of from 2 to 60% by weight, preferably 3 to 35% by weight and in particular 5 to 30% by weight, in the products.

Among the large number of ester quats which can be prepared and used according to the invention, those in which the alkanolamine is triethanolamine and the dicarboxylic acid is adipic acid have in turn proven particularly useful. Thus, for the purposes of the present invention, particular preference is given to products which comprise a reaction product of triethanolamine with a mixture of fatty acids and adipic acid in the molar ratio 1:5 to 5:1, preferably 1:3 to 3:1, which has then been quaternized in a manner known per se, in amounts of from 2 to 60% by weight, preferably 3 to 35% by weight and in particular 5 to 30% by weight, in the products.

The products according to the invention can—irrespective of whether they are formulated as textile detergents, washing auxiliaries or fabric softeners—also be equipped with further additional uses. In this respect, it is possible, for example, to formulate color transfer-inhibiting compositions, products with “anti-gray formula”, products which impart easier iron properties, products with a particular fragrance release, products with improved soil dissolution and prevention of resoiling, antibacterial products, UV protectants, color-freshening products etc. A few examples are described below.

Since fabrics, in particular those made of rayon, viscose, cotton and mixtures thereof, can tend to crease because the individual fibers are sensitive to bending, kinking, pressing, and squashing transversely to the direction of the fibers, the products according to the invention can comprise synthetic anticrease agents. These include, for example, synthetic products based on fatty acids, fatty acid esters. Fatty acid amides, fatty acid alkylol esters, fatty acid alkylolamides or fatty alcohols, which are mostly reacted with ethylene oxide, or products based on lecithin or modified phosphoric esters.

To control microorganisms, the products according to the invention can comprise antimicrobial active ingredients. A distinction is drawn here, depending on the antimicrobial spectrum and activity mechanism, between bacteriostats and bactericides, fungistats and fungicides etc. Important substances from these groups are, for example, benzalkonium chlorides, alkylaryl-sulfonates, halophenols and phenol mecuriacetate, it also being possible to dispense entirely with these compounds in the case of the products according to the invention.

In order to prevent undesired changes to the products and/or the treated textiles caused by the effect of oxygen and other oxidative processes, the products can comprise antioxidants. This class of compound includes, for example, substituted phenols, hydroquinones, pyrocatechins and aromatic amines, and also organic sulfides, polysulfides, dithiocarbamates, phosphites and phosphonates.

Increased wear comfort can result from the additional use of antistats which are additionally added to the products according to the invention. Antistats increase the surface conductivity and thus permit an improved flow of the charges formed. External antistats are usually substances with at least one hydrophilic molecular ligand and produce a more or less hygroscopic film on the surfaces. These mostly surface-active antistats can be subdivided into nitrogen-containing antistats (amines, amides, quaternary ammonium compounds), phosphorus-containing antistats (phosphoric esters) and sulfur-containing antistats (alkylsulfonates, alkyl sulfates). Lauryl-(or stearyl-)dimethylbenzylammonium chlorides are suitable as antistats for textiles or as additives for detergents, in which case a softening effect is additionally achieved.

To improve the water-absorption capacity, the rewettability of the treated textiles and to make ironing easier, silicone derivatives, for example, can be used in the products according to the invention. These additionally improve the rinse-out behavior of the products according to the invention by their foam-inhibiting properties. Preferred silicone derivatives are, for example, polydialkyl- or alkylarylsiloxanes in which the alkyl groups have one to five carbon atoms and are completely or partially fluorinated. Preferred silicones are polydimethylsiloxanes which can optionally be derivatized and then are aminofunctional or quaternized, or have Si—OH, Si—H and/or Si—Cl bonds. The viscosities of the preferred silicones are, at 25° C., in the range between 100 and 100 000 centistokes, it being possible to use the silicones in amounts between 0.2 and 5% by weight, based on the total product.

Finally, the products according to the invention can also comprise UV absorbers, which attach to the treated textiles and improve the photoresistance of the fibers. Compounds which have these desired properties are, for example, the compounds and derivatives of benzophenone having substituents in the 2- and/or 4-position which are effective as a result of nonradiative deactivation. Furthermore, substituted benzotriazoles, acrylates phenyl-substituted in the 3-position (cinnamic acid derivatives), optionally with cyano groups in the 2-position, salicylates, organic Ni complexes, and natural substances such as umbelliferone and endogenous urocanic acid are also suitable.

### EXAMPLES

### Example 1

Enclosures according to the invention in the form of hemispheres, cups with an internal radius of 24 mm were produced by injection molding on a hydraulic screw injection molding machine model 221 M from Arburg. These cups were then each optionally filled with product and (both in the filled and also in the unfilled variants) sealed in a liquid-tight manner with a sealed-on, likewise water-soluble cover film.

Finally, the products were tested in mechanical load tests with respect to their strength and leakproofness.

The water-soluble coating material for accommodating the cleaning-active composition was a thermoplastically processible PVA blend from Texas Polymers, USA, type “Vinex 2019” (melt flow index 26-30; 2.16 kg; 190° C.). The polymer pellets, metered in via a metering screw, were introduced into the injection molding extruder and melted with increasing temperature profile from the intake to the die head (zone 1: 140° C.; zones 2 to 5: 160° C. to 195° C.; die: 210° C.), then passed to the cyclically closed injection mold via the feed point to mold the articles.

The halves of the half-shells were each filled with 25 ml of the cleaning product composition with a low content of water described below.

Low Water Content ADD Cleaning Product Formulation [%]:

| | |
|---|---|
| Sodium carbonate | 16.0 |
| Sodium tripolyphosphate | 71.7 |
| Sodium perborate | 5.0 |
| Tetraacetylethylenediamine | 1.25 |
| Benzotriazole | 0.5 |
| C12-fatty alcohol with 3 EO | 1.25 |
| Dye | 0.1 |
| Enzymes | 3.0 |
| Perfume | 0.2 |
| Silicone oil | 1.0 |

The filled/unfilled half-shells were then sealed along a circumferential rim (margin width 2 mm) with a water-soluble PVA film in a multicavity heat-sealing tool from Illig Maschinenbau (sealing temperature 180-190° C.) and projecting film material is then removed by punching (optionally along or together with the protruding margin rim). Two types of PVA film were used, as are known from the production of conventional portion pouches (PVA pouches) containing washing- or cleaning-active compositions: Aicello SA 75, Greensol M 8630.

The enclosures were subjected to mechanical strain tests using a universal testing machine from Zwick, model 1425, these mechanical measurements being made both directly following production of the enclosures, and also after conditioning for a standardized climate of 23° C. and 50% relative humidity (12 hours).

The following results were obtained:

deformation work w and recovery rate v of the unfilled cups for a compression travel of 22 mm along the shortest axis

(empty cups lying on the film side; indentation test with 8 mm round rod):

| | | | | Number of |
|---|---|---|---|---|
| Empty PVA cups, | Force F₁ | | v | possible |
| wall thickness s | [N] | w [Nm] | [mm/min] | repeat runs |
| s = 0.55 mm | 12.3 ± 0.1 | 0.18 ± 0.005 | <1 | >5 |

F₁: deformation force
w: deformation work
v: recovery rate

| | | Number of |
|---|---|---|
| Filled PVA cups, | Force Fₘₐₓ | repeat |
| wall thickness s | [N] | measurements |
| s = 0.55 mm | 332 ± 53 | >5 |

Fₘₐₓ: compression resistance in accordance with DIN 555526.1 (filled cups lying on film side)

### Example 2

Extrusion-blown, water-soluble enclosures were prepared in line in a blow-fill-seal process and then tested with regard to their repeated mechanical load-bearing capacity.

For this, in this case example, 50 ml of liquid detergent portions were prepared in the form of spheres with an external diameter of 47.7 nm and provided on both sides with a 4 mm-deep engraving by the following process.

In a batch-cycled blow-fill-seal machine from Rommelag/Kocher-Plastik model “bottlepack plant 2012” (with quadruple blowing die, with sequential feed), in different runs, diverse blow-extrudable PVA compounds (e.g. “Vinex 2034” ex Texas Polymers and “L 734”, “KSE Mowiflex LPTC 221” ex Clariant/Kuraray) were thermoplastically melted with uniform and increasing temperature profile (180° C. extruder zones, 180 to 196° C. blowing die) in the extruder and blown simultaneously to give four parisons.

The parisons extruded from the PVA blend were fed into the opened blow mold and the parisons were cropped using a die nut (hot slicer) below the mold.

In a subsequent step, the mold was closed, as a result of which the base of the respective parison was thermally sealed via the clamping action. By means of an integrated blowing and filling side-feed unit, inserted into the neck area of the particular parison in the mold, by means of compressed air and by means of a vacuum applied to the inside of the mold, the respective parison was shaped against the spherical cavity plates of the respective mold cavities.

The total coating weight was 1.5 g in an example experiment, with products very regularly shaped in all four cavities with regard to their wall thicknesses (wall thickness s in the region of the base jaws about 300 μm; in the equatorial region, at the nominal breaking point, about 70 to 100 μm).

Each enclosure was filled by means of the integrated blowing and filling side-fed unit with 50 ml of a liquid detergent formulation with a low water content and of the following composition.

| Raw material | Amount in percent by weight |
|---|---|
| Glycerol | 1.0 |
| Ethanol | 3.26 |
| Morlox MO 154^{[a]} | 22.5 |
| LAS-MEA^{[b]} | 24.5 |
| Edenor K12-18^{[c]} | 17.5 |
| Dequest 2066^{[d]} | 0.6 |
| Polygel W30^{[e]} | optionally 0.2 |
| Ethanolamine | 4.9 |
| BLAP S260 SLD2^{[f]} | 1.0 |
| Termanyl 300 LDX^{[g]} | 0.2 |
| Carezym 4500L^{[h]} | 0.06 |
| Water | 6.0 |
| Tinopal CBS-CL^{[i]} | 0.045 |
| Dye | + |
| Perfume | + |
| Propylene glycol | ad 100 |

^{[a]}C₁₂₋₁₄-fatty alcohol + 5 EO + 4 PO ex Sasol
^{[b]}Dodecylbenzenesulfonic acid monoethanolamine salt ex Sasol
^{[c]}Coconut oil fatty acid cut (C₈₋₁₈-fatty acid) ex Cognis
^{[d]}Diethylenetriaminepentamethylenephosphonic acid hepta-sodium salt ex Solutia
^{[e]}Acrylic copolymer, containing carboxyl groups ex 3 V Sigma
^{[f]}Protease ex Biozym
^{[g]}Amylase ex Novo
^{[h]}Cellulase ex Novo
^{[i]}Distyrylbiphenyl derivative, anionic ex Ciba

After the filling, the integrated, quadruple blowing and filling side-feed unit was withdrawn from the die and then the upper jaws of the die were closed so that the required sealing of the enclosure to give a liquid-tight PVA container took place by means of heat sealing.

To test the mechanical load-bearing capacity, compression tests with a round rod Ø=8 mm were carried out on a Zwick testing machine for a test distance of 22 mm traveled vertically in multiple determination (repeat measurement on each of one enclosure by carrying out the same test program a number of times).

The table below with the test values reveals that the deformation work determined for the filled enclosures described above have, upon multiple measurement, a standard deviation below 1% of the average.

Penetration Test with Round Rod Ø=8 mm, 22 mm test Distance, on Zwick Testing Machine

After storage period of
several days

| Multiple determination: | | Deformation work |
|---|---|---|
| in each case nth pass | F₁ [N] | w [Nm] |
| 1. | 16.6 | 0.108 |
| 2. | 16.8 | 0.106 |
| 3. | 16.7 | 0.105 |
| 4. | 16.6 | 0.104 |
| 5. | 16.7 | 0.104 |
| 6. | 16.8 | 0.105 |
| 7. | 16.8 | 0.104 |
| 8. | 16.8 | 0.104 |
| Average | 16.7 | 0.105 |
| Standard deviation | 0.1 | 0.001 |
| Standard deviation [%] | 0.6 | 0.9 |

### Example 3

Formulated consumer packs, which each contained 12 of the enclosures according to example 2 stored loose in a polyethylene bag, this polyethylene bag being in turn within a cardboard box, were subjected to dropping tests. The enclosures according to the invention withstood a drop from a height of 2 m without the appearance of damage or leaks without problems.

What is claimed is:

1. A portioned washing, rinsing, or cleaning product, comprising a preparation that is surrounded by an enclosure, wherein the unfilled enclosure
is deformable by a force F₁>0 N and ≦500 N along a path s₁ and, after the influence of force has ceased, returns in the direction of its original shape and/or
after the influence of the deformation force has ceased, has a recovery rate v>0 mm/min and ≦1000 mm/min.

2. The portioned product of claim 1, wherein the unfilled enclosure returns to its original shape after the influence of force has ceased.

3. The portioned product of claim 1, wherein the unfilled enclosure is deformable by a force F₂≦100 N.

4. The portioned product of claim 3, wherein the unfilled closure is deformable by a force F₃≦60 N.

5. The portioned product of claim 4, wherein the unfilled closure is deformable by a force F₄≦40 N.

6. The portioned product of claim 5, wherein the unfilled closure is deformable by a force F₅≦20 N.

7. The portioned product of claim 1, wherein the unfilled enclosure, after the influence of force has ceased, has a recovery rate v of ≦500 mm/min.

8. The portioned product of claim 7, wherein the unfilled enclosure, after the influence of force has ceased, has a recovery rate v≦100 mm/min.

9. The portioned product of claim 8, wherein the unfilled enclosure, after the influence of force has ceased, has a recovery rate v≦50 mm/min.

10. The portioned product of claim 9, wherein the unfilled enclosure, after the influence of force has ceased, has a recovery rate v≦10 mm/min.

11. The portioned product of claim 10, wherein the unfilled enclosure, after the influence of force has ceased, has a recovery rate v≦1 mm/min.

12. The portioned product of claim 1, wherein for the deformation of the unfilled enclosure, a deformation work w of ≦5 Nm is required.

13. The portioned product of claim 12, wherein for the deformation of the unfilled enclosure, a deformation work w≦1 Nm is required.

14. The portioned product of claim 13, wherein for the deformation of the unfilled enclosure, a deformation work w≦0.5 Nm is required.

15. The portioned product of claim 14, wherein for the deformation of the unfilled enclosure, a deformation work w≦0.3 Nm is required.

16. The portioned product of claim 15, wherein for the deformation of the unfilled enclosure, a deformation work w≦0.25 Nm is required.

17. A washing, rinsing or cleaning product, comprising a preparation that fills an enclosure, wherein the filled enclosure
is deformable by a force F₁>0 N and ≦500 N and, after the influence of force has ceased, returns in the direction of its original shape and/or
has a recovery rate v of >0 mm/min and ≦1000 mm/min after the influence of deformation force has ceased.

18. The product of claim 17, comprising a preparation that fills an enclosure, wherein the filled enclosure
is deformable by a force F₂≦100 N and, after the influence of force has ceased, returns in the direction of its original shape and/or
has a recovery rate v of >0 mm/min and ≦1000 mm/min after the influence of deformation force has ceased.

19. The product of claim 18, comprising a preparation that fills an enclosure, wherein the filled enclosure
is deformable by a force F₃≦60 N and, after the influence of force has ceased, returns in the direction of its original shape and/or
has a recovery rate v of >0 mm/min and ≦1000 mm/min. after the influence of deformation force has ceased.

20. The product of claim 19, comprising a preparation that fills an enclosure, wherein the filled enclosure
is deformable by a force F₄≦20 N and, after the influence of force has ceased, returns in the direction of its original shape and/or,
has a recovery rate v of >0 mm/min and ≦1000 mm/min after the influence of deformation force has ceased.

21. The product of claim 17, wherein the filled enclosure, after the influence of force has ceased, has a recovery rate v of ≦500 mm/min.

22. The product of claim 21, wherein the filled enclosure, after the influence of force has ceased, has a recovery rate v of ≦100 mm/min.

23. The product of claim 22, wherein the filled enclosure, after the influence of force has ceased, has a recovery rate v of ≦50 mm/min.

24. The product of claim 23, wherein the filled enclosure, after the influence of force has ceased, has a recovery rate v of ≦10 mm/min.

25. The product of claim 24, wherein the filled enclosure, after the influence of force has ceased, has a recovery rate v of ≦1 mm/min.

26. The product of claim 17, wherein for the deformation of the filled enclosure, a deformation work w≦5.0 Nm is required.

27. The product of claim 26, wherein for the deformation of the filled enclosure, a deformation work w≦2.5 Nm is required.

28. The product of claim 27, wherein for the deformation of the filled enclosure, a deformation work w≦1.0 Nm is required.

29. The product of claim 28, wherein for the deformation of the filled enclosure, a deformation work w≦0.75 Nm is required.

30. The product of claim 29, wherein for the deformation of the filled enclosure, a deformation work w of ≦0.5 Nm is required.

31. The product of claim 17, wherein the filled enclosure has a crushing resistance Fₘₐₓ of 20 to 2000 N.

32. The product of claim 31, wherein the filled enclosure has a crushing resistance Fₘₐₓ of 50 to 1000 N.

33. The product of claim 32, wherein the filled enclosure has a crushing resistance Fₘₐₓ of 75 to 600 N.

34. The product of claim 33, wherein the filled enclosure has a crushing resistance Fₘₐₓ of 100 to 500 N.

35. The product of claim 34, wherein the filled enclosure has a crushing resistance Fₘₐₓ of 150 to 400 N.

36. The portioned product of claim 1, wherein the filled or unfilled enclosure, upon n-fold, where n is ≧2, repetition of a measurement of recovery rate, deformation work or crushing resistance, the quantity measured has a percentage standard deviation, based on the average measurement value, of less than 100%.

37. The portioned product of claim 36, wherein the quantity measured has a percentage standard deviation of less than 50%.

38. The portioned product of claim 37, wherein the quantity measured has a percentage standard deviation of less than 40%.

39. The portioned product of claim 38, wherein the quantity measured has a percentage standard deviation of less than 30%.

40. The portioned product of claim 39, wherein the quantity measured has a percentage standard deviation of less than 20%

41. The portioned product of claim 40, wherein the quantity measured has a percentage standard deviation of less than 10%.

42. The portioned product of claim 41, wherein the quantity measured has a percentage standard deviation of less than 8%.

43. The portioned product of claim 42, wherein the quantity measured has a percentage standard deviation of less than 5%.

44. The portioned product of claim 43, wherein the quantity measured has a percentage standard deviation of less than 3%.

45. The portioned product of claim 44, wherein the quantity measured has a percentage standard deviation of less than 2%.

46. The portioned product of claim 45, wherein the quantity measured has a percentage standard deviation of less than 1%.

47. The portioned product of claim 1, wherein the enclosure has a wall thickness of 100 to 5000 μm.

48. The portioned product of claim 47, wherein the enclosure has a wall thickness of 200 to 3000 μm.

49. The portioned product of claim 48, wherein the enclosure has a wall thickness of 300 to 2000 μm.

50. The portioned product of claim 49, wherein the enclosure has a wall thickness of 500 to 1500 μm.

51. The product of claim 17, wherein the enclosure has a wall thickness of 100 to 5000 μm.

52. The product of claim 51, wherein the enclosure has a wall thickness of 200 to 3000 μm.

53. The product of claim 52, wherein the enclosure has a wall thickness of 300 to 2000 μm.

54. The product of claim 53, wherein the enclosure has a wall thickness of 500 to 1500 μm.

55. The portioned product of claim 1, wherein the enclosure comprises one or more materials selected from the group consisting of acrylic acid-containing polymers, polyacrylamides, oxazoline polymers, polystyrenesulfonates, polyurethanes, polyesters, graft polymers, polyethers, and mixtures thereof.

56. The portioned product of claim 1, wherein the enclosure comprises one or more water-soluble polymers selected from the group consisting of (optionally acetylated) polyvinyl alcohol (PVAL), polyvinyl-pyrrolidone, polyalkylene oxides, gelatin, cellulose, and derivatives and mixtures thereof.

57. The portioned product of claim 56, wherein the enclosure comprises a polyvinyl alcohol whose degree of hydrolysis is 70 to 100 mol %.

58. The portioned product of claim 57, wherein the polyvinyl alcohol has a degree of hydrolysis of 80 to 90 mol %.

59. The portioned product of claim 58, wherein the polyvinyl alcohol has a degree of hydrolysis of 81 to 89 mol %.

60. The portioned product of claim 59, wherein the polyvinyl alcohol has a degree of hydrolysis of 82 to 88 mol %.

61. The portioned product of claim 56, wherein the enclosure comprises a polyvinyl alcohol having a molecular weight of 10,000 to 100,000 gmol⁻¹.

62. The portioned product of claim 61, wherein the polyvinyl alcohol has a molecular weight of 11,000 to 90,000 gmol⁻¹.

63. The portioned product of claim 62, wherein the polyvinyl alcohol has a molecular weight of 12,000 to 80,000 gmol⁻¹.

64. The portioned product of claim 63, wherein the polyvinyl alcohol has a molecular weight of 13,000 to 70,000 gmol⁻¹.

65. The portioned product of claim 56, wherein the enclosure comprises a polyvinyl alcohol having a degree of polymerization of about 200 to about 2100.

66. The portioned product of claim 65, wherein the enclosure comprises a polyvinyl alcohol having a degree of polymerization of about 220 to about 1890.

67. The portioned product of claim 66, wherein the enclosure comprises a polyvinyl alcohol having a degree of polymerization of about 240 to about 1680.

68. The portioned product of claim 67, wherein the enclosure comprises a polyvinyl alcohol having a degree of polymerization of about 260 to about 1500.

69. The portioned product of claim 56, wherein the enclosure comprises at least 50% by weight of the one or more water-soluble polymers.

70. The portioned product of claim 69, wherein the enclosure comprises at least 70% by weight of the one or more water-soluble polymers.

71. The portioned product of claim 70, wherein the enclosure comprises at least 80% by weight of the one or more water-soluble polymers.

72. The portioned product of claim 71, wherein the enclosure comprises at least 90% by weight of the one or more water-soluble polymers.

73. A process for the preparation of a washing, rinsing or cleaning product in portions, comprising the steps of forming by one or more of injection molding, extrusion blowing, or thermoforming an enclosure, wherein the unfilled enclosure
is deformable by a force F₁>0 N and ≦500 N along a path s₁ and, after the influence of force has ceased, returns in the direction of its original shape and/or
after the influence of the deformation force has ceased, has a recovery rate v>0 mm/min and ≦1000 mm/min,
filling the enclosure with a washing, rinsing or cleaning product portion, and sealing the filled enclosure.
